(19) United States
(12) Patent Application Publication
(10) Pub. No.: US 2021/0306986 A1
(43) Pub. Date: Sep. 30, 2021

(54) USER TERMINAL

(71) Applicant: NTT DOCOMO, INC., Tokyo (JP)

(72) Inventors: Hideaki Takahashi, Chiyoda-ku, Tokyo (JP); Kazuki Takeda, Chiyoda-ku, Tokyo (JP); Hiroki Harada, Chiyoda-ku, Tokyo (JP)

(73) Assignee: NTT DOCOMO, INC., Tokyo (JP)

(21) Appl. No.: 17/270,222

(22) PCT Filed: Aug. 23, 2018
(86) PCT No.: PCT/JP2018/031184

§ 371 Date: Feb. 22, 2021

(51) Int. Cl. H04W 72/02; H04W 72/04; H04W 68/00

(52) U.S. Cl. CPC H04W 72/02; H04W 72/0453; H04W 76/28; H04W 68/00; H04W 72/042

(57) ABSTRACT

A user terminal according to one aspect of the present disclosure includes: a receiving section that receives downlink control information for a paging; and a control section that determines a frequency domain resource from a plurality of frequency domain resources based on a user terminal-specific identifier, the frequency domain resource being used to receive the downlink control information, and the plurality of frequency domain resources being provided in a slot for monitoring the downlink control information.

### TECHNICAL FIELD

The present disclosure relates to a user terminal of a next-generation mobile communication system.

### BACKGROUND ART

In Universal Mobile Telecommunications System (UMTS) networks, for the purpose of higher data rates and lower latency, Long Term Evolution (LTE) has been specified (Non-Patent Literature 1). Furthermore, for the purpose of a larger capacity and higher sophistication than those of LTE (LTE Rel. 8 and 9), LTE-Advanced (LTE-A and LTE Rel. 10 to 14) has been specified.

LTE successor systems (also referred to as, for example, Future Radio Access (FRA), the 5th generation mobile communication system (5G), 5G+ (plus), New Radio (NR), New radio access (NX), Future generation radio access (FX) or LTE Rel. 14, 15 or subsequent releases) are also studied.

Legacy LTE systems (e.g., LTE Rel. 8 to 13) support a Discontinuous Reception (DRX) operation in an idle mode to reduce power consumption of a user terminal (UE: User Equipment).

The user terminal in the idle mode monitors Downlink Control Information (DCI) (also referred to as, for example, DCI for a paging or paging DCI) for scheduling a downlink shared channel (e.g., PDSCH: Physical Downlink Shared Channel) for conveying a paging message in a Paging Occasion (PO) determined based on a DRX cycle.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

A future radio communication system (also referred to as NR below) supports DRX of a user terminal (UE: User Equipment) in an inactive (RRC_INACTIVE) mode in addition to an idle (RRC_IDLE) mode. The user terminal in the idle mode or the inactive mode controls reception of at least one of paging DCI and a paging message in a Paging Occasion (PO) determined based on a DRX cycle.

Furthermore, it is also studied for NR to time-multiplex pagings (at least one of pieces of paging DCI and paging messages scheduled by the pieces of paging DCI) of a plurality of UEs between different POs. However, there is a risk that only time-multiplexing pagings of a plurality of UEs between the different POs makes a capacity available for a paging a bottleneck.

The present disclosure has been made in light of this point, and one of objects of the present disclosure is to provide a user terminal that can increase a capacity available for pagings.

### Solution to Problem

A user terminal according to one aspect of the present disclosure is configured in: a reception section that receives downlink control information for a paging; and a control section that determines a frequency domain resource from a plurality of frequency domain resources based on a user terminal-specific identifier, the frequency domain resource being used to receive the downlink control information, and the plurality of frequency domain resources being provided in a slot for monitoring the downlink control information.

### Advantageous Effects of Invention

According to one aspect of the present disclosure, it is possible to increase a capacity available for pagings.

### BRIEF DESCRIPTION OF DRAWINGS

FIG. 1 is a diagram illustrating one example of PFs and POs.

FIG. 2 is a diagram illustrating one example of a plurality of CORESETs assigned for a paging search space according to a first aspect.

FIGS. 3A and 3B are diagrams illustrating one example of common PDCCH configuration information and CORESET configuration information according to the first aspect.

FIG. 4 is a diagram illustrating one example of search space configuration information according to the first aspect.

FIG. 5 is a diagram illustrating one example of a plurality of frequency domain resources in a CORESET assigned to a paging search space according to a second aspect.

FIG. 6 is a diagram illustrating one example of CORESET configuration information according to a second aspect.

FIG. 7 is a diagram illustrating one example of a plurality of FDM resources in a CORESET assigned to a paging search space according to a third aspect.

FIG. 8 is a diagram illustrating one example of CORESET configuration information according to the third aspect.

FIG. 9 is a diagram illustrating one example of a schematic configuration of a radio communication system according to the present embodiment.

FIG. 10 is a diagram illustrating one example of an overall configuration of a base station according to the present embodiment.

FIG. 11 is a diagram illustrating one example of a function configuration of the base station according to the present embodiment.

FIG. 12 is a diagram illustrating one example of an overall configuration of a user terminal according to the present embodiment.

FIG. 13 is a diagram illustrating one example of a function configuration of the user terminal according to the present embodiment.

FIG. 14 is a diagram illustrating one example of hardware configurations of the base station and the user terminal according to the present embodiment.

### DESCRIPTION OF EMBODIMENTS

(Discontinuous Reception for Paging)

According to NR, a user terminal (UE: User Equipment) in an idle (RRC_IDLE) mode or an inactive (RRC_INACTIVE) mode performs Discontinuous Reception (DRX) of a given cycle to reduce power consumption. The UE monitors one Paging Occasion (PO) per cycle of DRX (DRX cycle).

In this regard, the PO is a set of monitoring occasions (durations for monitoring or PDCCH monitoring occasions) of a downlink control channel (e.g., PDCCH: Physical Downlink Control Channel). The PO may be configured in one or more time domain resource units (e.g., one or more slots, one or more subframes or one or more symbols).

Downlink Control Information (DCI) (DCI for a paging or paging DCI) for scheduling a downlink shared channel (e.g., PDSCH: Physical Downlink Shared Channel) for conveying a paging message is transmitted in the PO. The paging DCI may be configured in a Cyclic Redundancy Check (CRC) bit that is scrambled by a given radio network temporary identifier (P-RNTI: Paging-Radio Network Temporary Identifier).

One Paging Frame (PF) is one radio frame, and may include one or more POs. Furthermore, the PF may be a PO start point. Each radio frame may be identified based on a System Frame Number (SFN).

The SFN of each radio frame that becomes the PF may be determined based on, for example, equation 1.

(SFN+PF_offset)mod T=(T div N)*(UE_ID mod N) [Equation 1]

Furthermore, an index i_s related to a start position of a set (PO) of PDCCH monitoring occasions for paging DCI may be determined based, for example, equation 2.

i_s=floor(UE_ID/N)mod Ns, where Ns=max(1,nB/IT) holds [Equation 2]

For example, T may represent a DRX cycle of the UE in equation 1 or 2. T may be determined based on a minimum value of a UE-specific DRX cycle. Alternatively, when the UE-specific DRX cycle is not configured, T may be determined based on a default DRX cycle (cell-specific DRX cycle) broadcast by system information. In addition, the DRX cycle may be paraphrased as a paging cycle.

nB may represent a total number of POs in T. N represents a total number of PFs in the paging cycle T, and may be, for example, min(T, nB). PF_offset represents an offset used to determine a PF. Ns may represent the number of POs in one PF.

UE_ID represents a value based on a subscriber identity (IMSI: International Mobile Subscriber Identity), and may be, for example, IMSI mod 1024. In addition, UE_ID is not limited to the value based on the IMSI, and may be any value based on a UE-specific identifier.

At least one of the above parameters nB and PF_offset and default DRX cycle may be signaled by a System Information Block (SIB) 1 or an RRC reconfiguration message.

When information (paging search space information, paging-SearchSpace or pagingSearchSpace) related to a search space for a paging is configured by a higher layer signaling, a PDCCH monitoring occasion for a paging may be determined based on the paging search space information. The paging search space information may be, for example, a search space Identifier (ID) for a paging.

When the paging search space information is not configured by a higher layer signaling, the PDCCH monitoring occasion may be configured based on information (Remaining Minimum System Information (RMSI) search space information, rmsi-SearchSpace or searchSpaceSIB1) related to a search space for RMSI. The RMSI search space information may be, for example, a search space ID for the RMSI.

In this regard, the higher layer signaling may be, for example, an RRC signaling, broadcast information (such as a Master Information Block (MIB) or a System Information Block (SIB)), or a Medium Access Control (MAC) signaling (e.g., an MAC Control Element (MAC CE)).

When the paging search space information is configured by a higher layer signaling, the UE may monitor a (i_s+1)th PO at which the first PO in the PF starts.

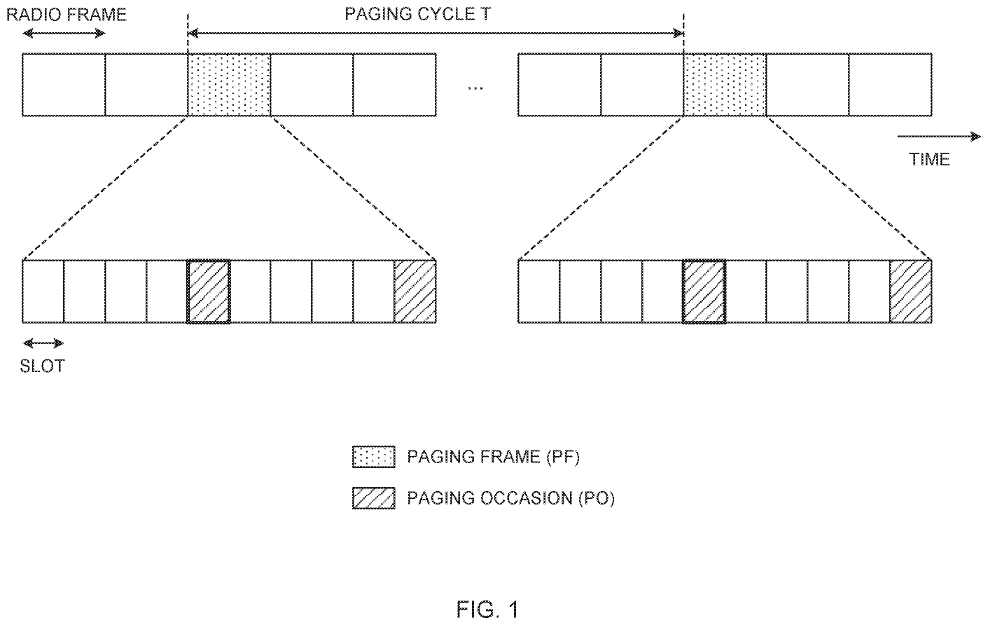

FIG. 1 is a diagram illustrating one example of PFs and POs. In addition, FIG. 1 exemplifies a case where the number of slots per radio frame is 10. However, the number of slots per radio frame is not limited to this. The number of slots per radio frame may differ per Sub-Carrier Spacing (SCS) or information (sp) that indicates the SCS.

Furthermore. FIG. 1 illustrates an example where two POs are provided in 1 PF. However, the number of POs in 1 PF may be other than 2. Furthermore, one PO may be configured in 1 or more contiguous slots.

In FIG. 1, N PFs and nB POs may be included in the paging cycle T. For example, the number Ns of POs in the PF is 2 in FIG. 1. The N PFs in the paging cycle T may be multiplexed (time-multiplexed) with a plurality of UEs based on UE_ID. The PF to be assigned to the UE in the paging cycle T may be determined based on the IMSI of the UE by using, for example, above equation 1.

Furthermore, the Ns POs in the PF may be multiplexed (time-multiplexed) with one or more UEs based on UE_ID. The PO to be assigned to the UE may be determined based on the IMSI of the UE by using, for example, above equation 2. For example, the first PO of the two POs included in each PF is assigned to the UE in FIG. 1.

By the way, it is studied for NR to realize at least one of expansion of a coverage and reduction of radio wave propagation loss by using Beam Forming (BF) for at least one of transmission and reception (transmission/reception). For example, a high frequency range (millimeter wave (mmWave)) such as 24250 MHz to 52600 MHz is used in a Frequency Range (FR) 2, and therefore use of BF is studied.

BF is a technique that forms a beam (antenna directionality) by, for example, using super multi-element antennas and controlling (also referred to as precoding) an amplitude and/or a phase of a signal transmitted/received from and at each super multi-element antenna element. In addition. Multiple Input Multiple Output (MIMO) that uses these super multi-element antennas is also referred to as massive MIMO.

BF can be classified into digital BF and analog BF. Digital BF is a method for performing precoding signal processing (on a digital signal) on a baseband, and can form beams the number of which corresponds to the number of antenna ports (or RF chains) at an arbitrary timing.

Analog BF is a method that uses a phase shifter on a Radio Frequency (RF). In this case, the phase of an RF signal is only rotated, and therefore a configuration is easy and can be realized at low cost, yet cannot form a plurality of beams at the same timing. Transmission/reception that uses a different beam per given time is also referred to as, for example, beam sweep (beam sweeping or sweeping).

According to a multi-beam operation during which beam sweeping is performed, the duration of the above PO may be one duration of beam sweeping. The UE may assume that the same paging message is repeatedly transmitted by all beams of a sweeping pattern. Selection of a beam for receiving the paging message may depend on UE implementation.

However, when a signal (common control signal) that is common to one or more UEs such as a paging message or a broadcast message (e.g., Master Information Block (MIB)) is repeatedly transmitted by all beams of the sweeping pattern, there is a risk that an overhead increases. Furthermore, there is also a risk that a paging capacity becomes a bottleneck.

Hence, the inventors of the present invention have conceived increasing a paging capacity by not only time-multiplexing pagings but also multiplexing (frequency-multiplexing) the pagings in a frequency domain. Furthermore, the inventors of the present invention have conceived determining a frequency domain resource used to receive pagings from a plurality of frequency domain resources provided in a PO based on a UE-specific identifier (e.g., IMSI), and thereby appropriately controlling reception of the pagings even when the pagings of a plurality of UEs are frequency-multiplexed.

The present embodiment will be described in detail below with reference to the drawings. A plurality of frequency domain resources provided in the PO in the present embodiment may be one of, for example, a plurality of CORESETs (first aspect), a plurality of frequency domain resources in a single CORESET (second aspect), and a plurality of resources subjected to frequency division multiplexing in frequency domain resources assigned to a single CORESET (third aspect).

In addition, the present embodiment will describe an example where a plurality of UEs are time-multiplexed between a plurality of POs, and pagings (at least ones of pieces of paging DCI and paging messages) of a plurality of UEs are frequency-multiplexed in one PO, yet is not limited to this. Only frequency-multiplexing of the pagings of a plurality of UEs may be applied, and time-multiplexing may not be applied.

(First Aspect)

The first aspect will describe an example where pagings of a plurality of UEs are multiplexed in a frequency domain by using a plurality of CORESETs assigned for a paging search space.

In the first aspect, a UE determines a CORESET for receiving paging DCI from a plurality of these CORESETs based on UE_ID. Consequently, it is possible to disperse a plurality of UEs that receive the paging DCI in a plurality of CORESETs.

For example, the UE may determine an identifier of a CORESET (CORESET_ID) for receiving paging DCI by using following equation 3.

CORESET_ID=floor(UE_ID/N*Ns)mod N_{CORESET} [Equation 3]

In equation 3. UE_ID. N and Ns are as described with regard to above equations 1 and 2. N_{CORESET} may represent the number of CORESETs assigned for a paging search space. According to equation 3, by multiplying the total number N of PFs in a paging cycle T and the number Ns of POs in the PF, the total number of POs in the paging cycle T is determined. By dividing UE_ID by N*Ns, a plurality of UEs are dispersed in a time domain. By calculating a modulo of this division result by N_{CORESET}, a plurality of UEs are dispersed in a frequency domain.

In this regard, above equation 3 is only exemplary, and the UE may determine the CORESET for receiving the paging DCI based on at least one of UE_ID, an IMSI, N, Ns and N_{CORESET}.

Furthermore, as described above, an identifier of a CORESET for receiving paging DCI is an identifier (CORESET_ID) given to each CORESET configured by a higher layer signaling, yet is not limited to this. The CORESET identifier may be any parameter that indicates a CORESET such as an order (entry) of CORESETs configured by a higher layer signaling.

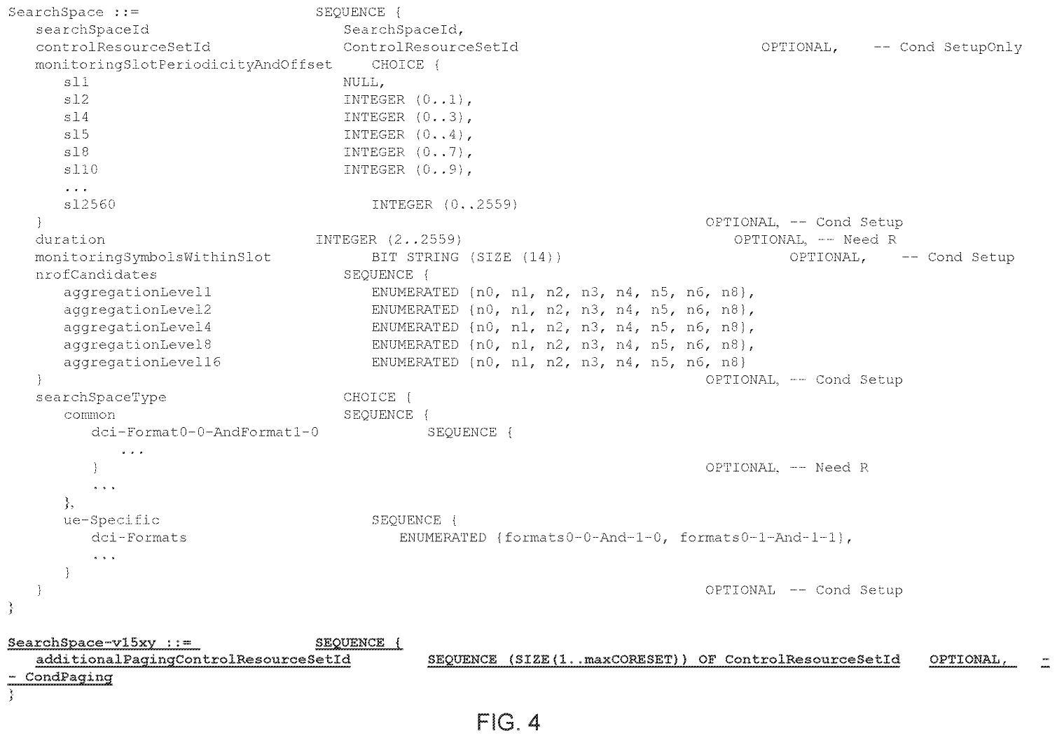

For example, in the order (entry) of the CORESETs, a first CORESET is a CORESET indicated by ControlResourceSetId in search space configuration information (FIG. 4) described below, and second and subsequent CORESETs may be CORESETs indicated in order by additionalPagingControlResourceSetId in SearchSpace-v15xy.

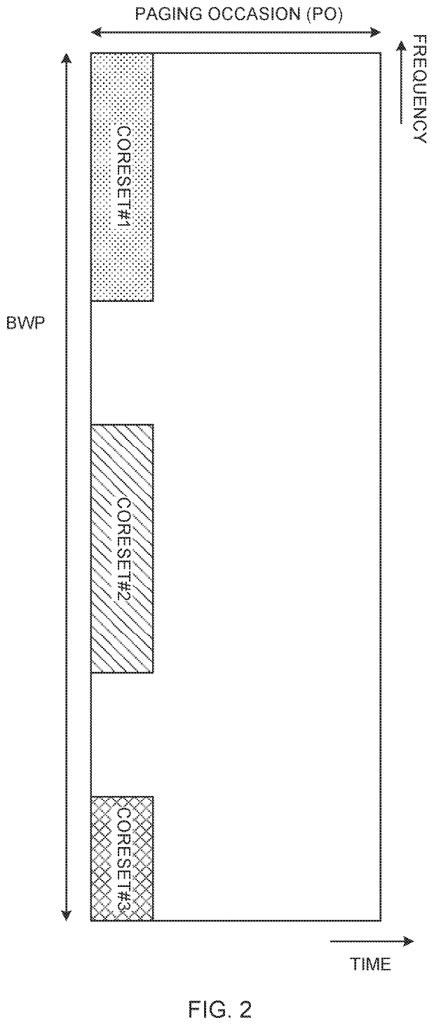

FIG. 2 is a diagram illustrating one example of a plurality of CORESETs assigned for a paging search space according to the first aspect. For example, in FIG. 2, a plurality of CORESETs (CORESETs #1 to #3 in FIG. 2) are assigned for a paging search space in a Bandwidth Part (BWP) in a cell (also referred to as, for example, a serving cell, a Component Carrier (CC) or a carrier).

In this regard, the BWP refers to a partial band in a carrier. In addition, a plurality of CORESETs for the paging search space are not limited in an identical BWP, and only need to be provided in a given bandwidth (e.g., cell) (or may be provided in different BWPs).

For example, the UE determines a PO of the UE by using above equations 1 and 2 in FIG. 2. However, the way the UE determines the PO is not limited to a method that uses above equations 1 and 2. The UE may determine a CORESET used to receive paging DCI from a plurality of CORESETs (e.g., CORESETs #1 to #3) assigned for a paging search space in the determined PO by using above equation 3.

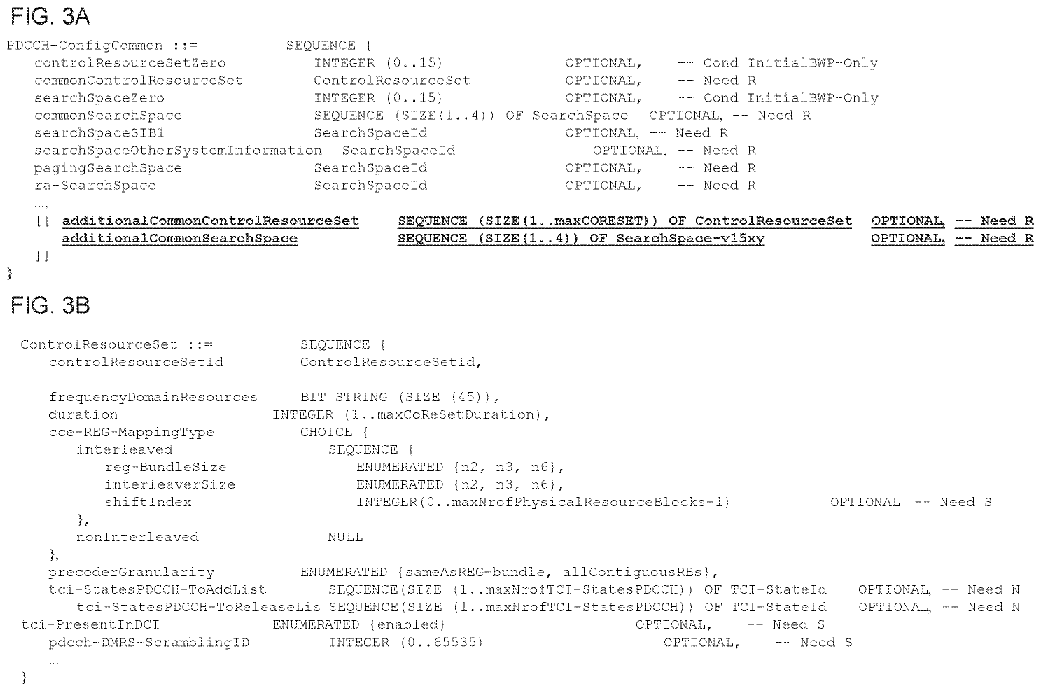

Assignment of a plurality of CORESETs for a paging search space in the UE will be described with reference to FIGS. 3A, 3B and 4. In addition, a hierarchical structure or an association of information illustrated in FIGS. 3A, 3B and 4 is only one example, and is not limited to this.

FIG. 3A illustrates one example of configuration information related to a PDCCH that is common to one or more UEs (i.e., cell-specific) (common PDCCH configuration information or PDCCH-ConfigCommon). FIG. 3B illustrates configuration information of one CORESET (CORESET configuration information or ControlResouceSet). FIG. 4 illustrates configuration information of one search space (search space configuration information or SearchSpace).

As illustrated in FIG. 3A, the common PDCCH configuration information (PDCCH-ConfigCommon) may include at least one following Information Element (IE):
Configuration information of a CORESET (common CORESET) that is commonly configured to one or more UEs (common CORESET configuration information or commonControlResouceSet),
Configuration information of a search space (common search space) that is commonly configured to the one or more UEs (common search space configuration information or commonSearchSpace),
The above paging search space information (pagingSearchSpace),
Configuration information of an additional common CORESET (additional common CORESET configuration information or additionalCommonControlResourceSet), and
Additional information related to a common search space (common search space additional information or additionalCommonSearchSpace).

commonControlResouceSet illustrated in FIG. 3A may include one CORESET configuration information (ControlResouceSet) illustrated in FIG. 3B. On the other hand, additionalCommonControlResourceSet illustrated in FIG. 3A may include a given number of (e.g., maxCORESET where maxCORESET≥1 holds) pieces of CORESET configuration information (ControlResouceSet) illustrated in FIG. 3B.

As illustrated in FIG. 3B, the CORESET configuration information (ControlResourceSet) may include at least one following IE:
An ID of the CORESET (controlResourceSetID),
Information that indicates a frequency domain resource assigned to the CORESET (frequencyDomainResources).
The number of symbols assigned to the CORESET (duration),
Information related to a mapping type of a CCE and an REG in the CORESET (a CCE-REG Mapping type or cce-REG-MappingType) (e.g., information that indicates whether or not interleaving is performed, and indicates at least one of an REG bundle size, an interleave size and a shift index when interleaving is performed),
Information that indicates a precoding granularity in a frequency domain (precoderGranularity),
A list of Transmission Configuration Indication (TCI) states to be associated with the CORESET (tci-StatesPDCCH-ToAddList) where the TCI state indicates a quasi co-location relationship between an antenna port (DMRS port) of a Demodulation Reference Signal (DMRS) of a PDCCH and a downlink reference signal, and
Information that indicates whether or not a TC field is present in DCI in the CORESET (tci-PresentInDCI).

commonSearchSpace illustrated in FIG. 3A may include a given number of (e.g., four at maximum) pieces of search space configuration information (SearchSpace) illustrated in FIG. 4.

As illustrated in FIG. 4, the search space configuration information (SearchSpace) may include at least one following IE:
A search space ID (searhSpaceId),
A CORESET ID associated with the search space (controlResourceSetId),
Information that indicates at least one of a cycle and an offset of a slot configured for monitoring of a PDCCH in the search space (monitoringSlotPeriodicityAndOffset),
Information that indicates the number of contiguous slots in the search space (duration),
Information that indicates a symbol for monitoring a PDCCH in a slot to which monitoring of the PDCCH is configured (monitoringSymbolsWithinSlot),
Information that indicates the number of PDCCH candidates per aggregation level in the search space (nrofCandidates),
Information that indicates a type of the search space (a common search space or a UE-specific search space) (searchSpaceType), and
Additional information related to the search space (e.g., paging search space) (SearchSpace-v15xy).

As illustrated in FIG. 4, SearchSpace-v15xy may include a given number of (e.g., maxCORESET where maxCORESET≥1 holds) CORESET identifiers (additionalPagingControlResourceSetId) to be applied to the paging search space.

Furthermore, additionalCommonSearchSpace illustrated in FIG. 3A may include a given number of (e.g., four at maximum) SearchSpace-v15xy illustrated in FIG. 4.

The UE can configure one or more CORESETs based on additionalCommonControlResourceSet illustrated in FIG. 3A in addition to a single CORESET configured based on commonControlResouceSet illustrated in FIG. 3A.

Furthermore, the search space configuration information (SearchSpace) associated with the paging search space identified based on paginSearchSpace illustrated in FIG. 3A includes maxCORESET additionalPagingControlResourceSetId in SearchSpace-v15xy in addition to single controlResourceSetId associated with the paging search space as illustrated in FIG. 4.

The UE can assign a CORESET (e.g., a CORESET #1 in FIG. 2) configured based on this controlResourceSetId, and one or more CORESETs (e.g., CORESETs #2 and #3 in FIG. 2) configured based on this additionalPagingControlResourceSetId for the paging search space.

The UE can determine a CORESET for receiving (monitoring) paging DCI from a plurality of CORESETs for a paging search space assigned as described above based on UE_ID by using, for example, above equation 3.

As described above, according to the first aspect, a plurality of CORESETs are assigned for the paging search space, and a CORESET in which each of a plurality of UEs receives paging DCI is determined among a plurality of CORESETs based on UE_ID. Consequently, when pagings of a plurality of UEs are frequency-multiplexed, it is possible to appropriately control reception of the paging for the own UE.

(Second Aspect)

The second aspect will describe an example where pagings of a plurality of UEs are multiplexed in a frequency domain by using a plurality of frequency domain resources in a single CORESET assigned for a paging search space.

Each frequency domain resource in the single CORESET may be configured in, for example, one or more resource blocks (Physical Resource Blocks (PRBs)), one or more Resource Block Groups (RBGs), one Control Channel Elements (CCEs), a CCE group including one or more CCEs, one or more Resource Elements (REs), one or more Resource Element Groups (REGs), or one or more REG bundles (REG groups). In addition, one RBG may include one or more PRBs, one REG may include one or more REs, and one REG bundle may include one or more REGs.

According to the second aspect, a UE determines a frequency domain resource for receiving paging DCI from a plurality of frequency domain resources in a single CORESET assigned for a paging search space based on UE_ID. Consequently, it is possible to disperse a plurality of UEs that receive the paging DCI in a plurality of frequency domain resources in an identical CORESET.

For example, the UE may determine an identifier i of a frequency domain resource for receiving the paging DCI by using following equation 4.

i=floor(UE_ID/N*Ns)mod N_{freq} [Equation 4]

In equation 4, UE_ID. N and Ns are as described with regard to above equations 1 and 2. N_{freq} may represent the number of frequency domain resources in a CORESET assigned for the paging search space. According to equation 4, by multiplying the total number N of PFs in a paging cycle T and the number Ns of POs in the PF, the total number of POs in the paging cycle T is determined. By dividing UE_ID by N*Ns, a plurality of UEs are dispersed in a time domain. By calculating a modulo of this division result by N_{freq}, a plurality of UEs are dispersed in a frequency domain.

In this regard, above equation 4 is only exemplary, and the UE may determine the CORESET for receiving the paging DCI based on at least one of UE_ID, an IMSI, N, Ns and N_{q}.

Furthermore, as described above, an identifier of a frequency domain resource for receiving paging DCI in a CORESET associated with the paging search space may be an order (entry) of frequency domain resources configured in the CORESET by a higher layer signaling (e.g., RRC signaling).

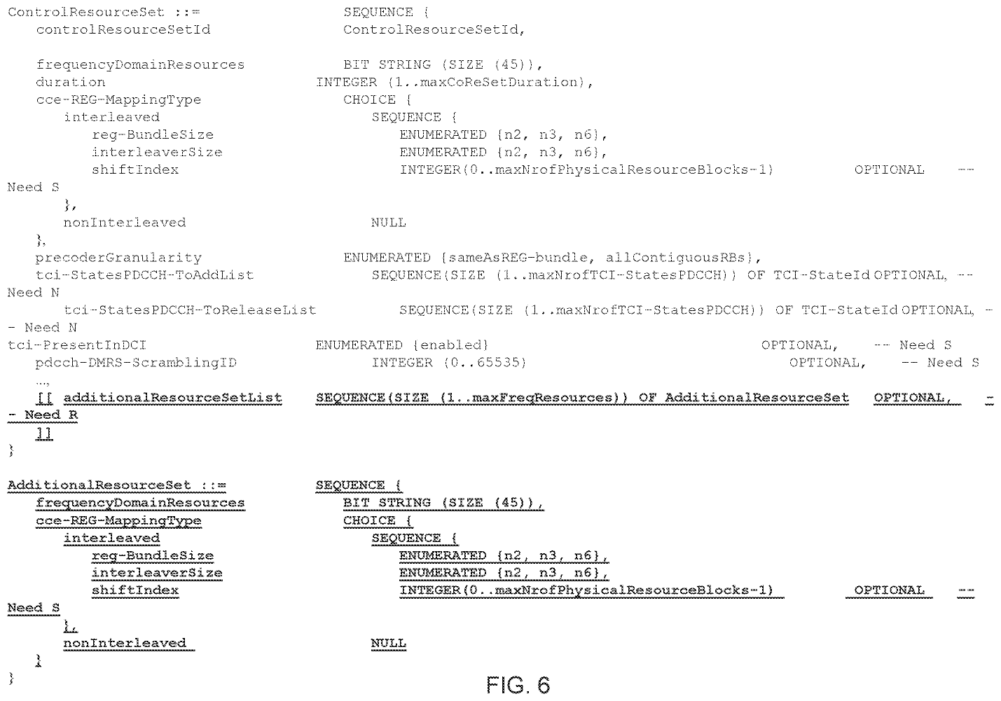

For example, in the order (entry) of the frequency domain resources of the CORESET, a first frequency domain resource is a frequency domain resource indicated by frequencyDoaminResources just beneath in CORESET configuration information (FIG. 6) described below, and second and subsequent frequency domain resources may be frequency domain resources indicated in order in additionalResouceSetList.

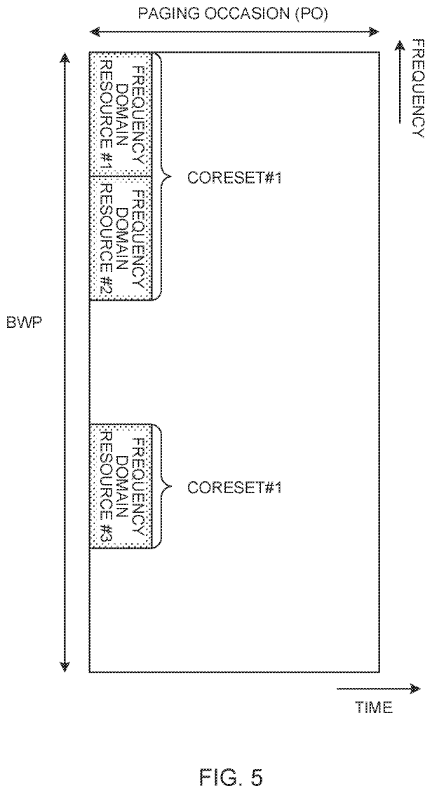

FIG. 5 is a diagram illustrating one example of a plurality of frequency domain resources in a CORESET assigned to the paging search space according to the second aspect. For example, a single CORESET #1 is assigned for (associated with) the paging search space in FIG. 5.

As illustrated in FIG. 5, the CORESET #1 associated with the paging search space may be configured to be configured in a plurality of frequency domain resources. As illustrated in FIG. 5, at least two of a plurality of frequency domain resources in the CORESET #1 may be contiguous or may be non-contiguous in the frequency domain.

In FIG. 5, each frequency domain resource in the CORESET #1 is configured in, for example, a given number of contiguous PRBs (e.g., 6 PRBs), yet is not limited to this.

For example, in FIG. 5, the UE determines the PO of the UE by using above equations 1 and 2. However, the way the UE determines the PO is not limited to the method that uses above equations 1 and 2. The UE may determine the frequency domain resource used to receive the paging DCI from a plurality of frequency domain resources (e.g., frequency domain resources #1 to #3) in the CORESET assigned for the paging search space in the determined PO by using above equation 4.

Assignment of a plurality of frequency domain resources in the single CORESET associated with the paging search space will be described with reference to FIG. 6. In addition, CORESET configuration information (ControlResourceSet) illustrated in FIG. 6 corresponds to a CORESET associated with the paging search space. The paging search space may be indicated by PagingSearchSpace in PDCCH-ConfigCommon in FIG. 3A. Furthermore, the CORESET associated with the paging search space may be indicated by ControlResourceSetId in search space configuration information (SearchSpace in FIG. 4) of the paging search space.

Furthermore, although not illustrated, additionalCommonControlResourceSet and additionalCommonSearchSpace are not included in PDCCH-ConfigCommon in FIG. 3A in the second aspect. Furthermore, SearchSpace-v15xy (maxCORESET additionalPagingControlResourceSetId) is not included in SearchSpace in FIG. 4.

As illustrated in FIG. 6, the CORESET configuration information (ControlResourceSet) of the CORESET associated with the paging search space may include a list related to additional frequency domain resources for a paging (an additional resource list or additionalresourceSetList) in addition to at least one IE illustrated in FIG. 3B, additionalresourceSetList may include a given number of (e.g., maxFreqResources where maxFreqResources≥1 holds) pieces of information related to the additional frequency domain resources for the paging (additional resource information or AdditionalResoureSet).

As illustrated in FIG. 6, AdditionalResoureSet may include at least one following IE:
Information that indicates the additional frequency domain resources (frequencyDomainResources), and
Information related to a mapping type of a CCE and an REG of the additional frequency domain resources (a CCE-REG Mapping type or cce-REG-MappingType) (e.g., information that indicates whether or not interleaving is performed, and indicates at least one of an REG bundle size, an interleave size and a shift index when interleaving is performed).

A hierarchical structure or an association of the above information is only one example, and is not limited to this. The information that indicates a plurality of frequency domain resources in the CORESET associated with the paging search space only needs to be configured to the UE.

The UE can configure one or more frequency domain resources based on frequencyDomainResources in additionalresourceSetList in addition to frequency domain resources configured based on frequencyDomainResources just beneath the CORESET configuration information (ControlResouceSet) illustrated in FIG. 6 for the CORESET associated with the paging search space.

In this regard, frequencyDomainResources just beneath ControlResouceSet, and firquencyDomainResources in each AdditionalResoureSet in additionalresourceSetList in FIG. 6 may be bitmaps per group (PRB group) of a given number of PRBs (e.g., 6 PRBs). A BWP to which a CORESET is configured may be segmented into one or more PRB groups, and whether or not each PRB group is assigned to the CORESET may be indicated by a bit value associated with each PRB group. In addition, the most significant bit may be associated with a PRB group of the lowest frequency in the BWP, and each subsequent bit may be also associated with each PRB group in order of a lower frequency.

For example, in FIG. 5, the UE can assign the frequency domain resource #1 configured based on frequencyDomainResources just beneath ControlResouceSet in FIG. 6, and the frequency domain resources #2 and #3 based on each frequencyDomainResources in additionalresourceSetList for the CORESET #1 associated with the paging search space.

The UE can determine a frequency domain resource for receiving (monitoring) paging DC from a plurality of frequency domain resources for a CORESET associated with a paging search space assigned as described above based on UE_ID by using, for example, above equation 4.

As described above, according to the second aspect, a plurality of frequency domain resources in the CORESET associated with the paging search space are assigned, and the CORESET in which each of a plurality of UEs receives paging DCI is determined among a plurality of these frequency domain resources based on UE_ID. Consequently, when pagings of a plurality of UEs are frequency-multiplexed, it is possible to appropriately control reception of a paging for the own UE.

(Third Aspect)

The third aspect will describe an example where pagings of a plurality of UEs are multiplexed in a frequency domain by using a plurality of resources (FDM resources: Frequency Division Multiplexed resources) subjected to frequency division multiplexing in a frequency domain resource assigned to a single CORESET assigned for a paging search space.

The third aspect differs from the second aspect in that the frequency domain resource assigned to the CORESET is configured in frequency resource units (e.g., PRBs or RBGs) that are contiguous in the frequency domain. The following third aspect will mainly describe differences from the second aspect.

In the third aspect, a UE determines an FDM resource for receiving paging DCI from a plurality of FDM resources in the frequency domain resource assigned to the CORESET based on UE_ID. Consequently, it is possible to disperse a plurality of UEs that receive the paging DCI in the frequency domain resource assigned to the CORESET.

For example, the UE may determine an identifier i of the FDM resource for receiving paging DCI by using following equation 5.

i=floor(UE_ID/N*Ns)mod N_{fdm} [Equation 5]

In equation 5, UE_ID, N and Ns are as described with regard to above equations 1 and 2. N_{fdm} may represent the number of FDM resources in the frequency domain resource configured to the CORESET assigned for a paging search space.

According to equation 5, by multiplying the total number N of PFs in a paging cycle T and the number Ns of POs in the PF, the total number of POs in the paging cycle T is determined. By dividing UE_ID by N*Ns, a plurality of UEs are dispersed in a time domain. By calculating a modulo of this division result by N_{fdm}, a plurality of UEs are dispersed in a frequency domain.

In this regard, above equation 5 is only exemplary, and the UE may determine the CORESET for receiving the paging DCI based on at least one of UE_ID, an IMSI, N, Ns and N_{fdm}.

Furthermore, in the above description, an identifier of the FDM resource for receiving the paging DCI in the CORESET associated with the paging search space may be an order of the FDM resources (information that indicates at what number each FDM resource is multiplexed) in the frequency domain resource assigned in the CORESET.

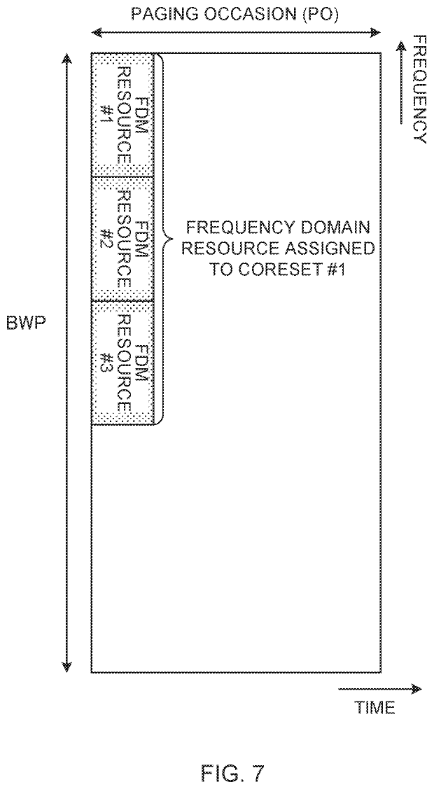

FIG. 7 is a diagram illustrating one example of a plurality of FDM resources in the CORESET assigned to the paging search space according to the second aspect. For example, in FIG. 7, a single CORESET #1 is assigned for (associated with) the paging search space.

As illustrated in FIG. 7, a frequency domain resource assigned to the CORESET #1 associated with the paging search space may be configured by performing frequency division multiplexing on a plurality of FDM resources.

In FIG. 7, each FDM resource in the frequency domain resource assigned to the CORESET #1 is configured in, for example, a given number of contiguous PRBs, yet is not limited to this, and may include given frequency resource units (a given number of RBGs or a given number of subcarriers). The number of the frequency resource units that make up each FDM resource may be determined based on the number of the frequency resource units (e.g., PRBs) assigned to the entire frequency domain resource assigned to the CORESET #1, and a number N_{fdm} of (e.g., 3 in FIG. 7) FDM resources in the frequency domain resource.

For example, the UE determines a PO of the UE by using above equations 1 and 2 in FIG. 7. However, the way the UE determines the PO is not limited to a method that uses above equations 1 and 2. The UE may determine an FDM resource used to receive paging DCI from a plurality of FDM resources (e.g., FDM resources #1 to #3) of the frequency domain resource assigned to the CORESET #1 in the determined PO by using above equation 5.

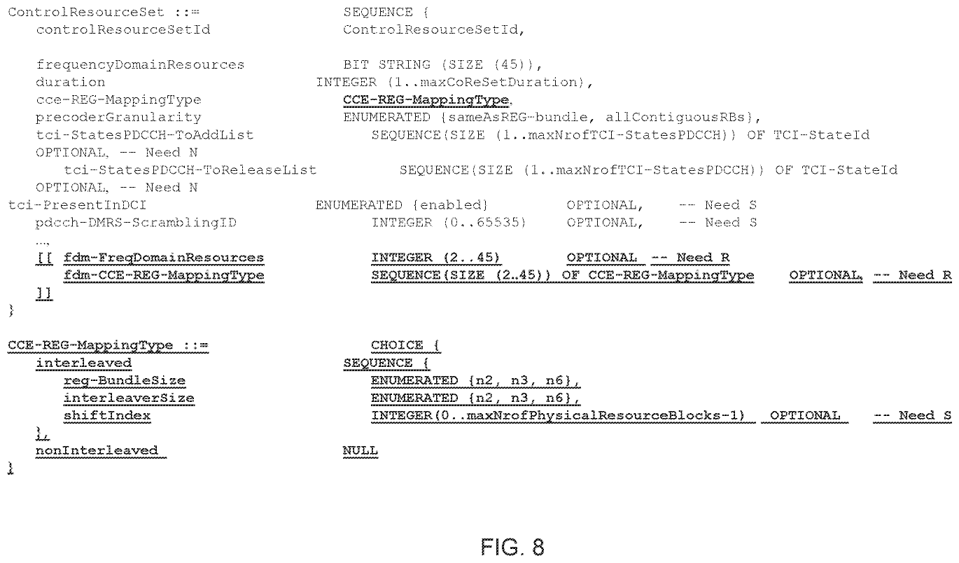

Assignment of a plurality of FDM resources of the frequency domain resource assigned to the CORESET for the paging search space will be described with reference to FIG. 8. Description of the same points as those in FIGS. 3B and 6 will be omitted, and differences will be mainly described with reference to FIG. 8.

As illustrated in FIG. 8, the CORESET configuration information (ControlResourceSet) of the CORESET associated with the paging search space may include at least one following IE:
Information that indicates the number of FDM resources in the frequency domain resource assigned to the CORESET (information of the number of FDM resources or fdm-FreqDomainResources), and
Information related to a mapping type of a CCE and an REG of each FDM resource (a CCE-REG Mapping type or cce-REG-MappingType) (e.g., information that indicates whether or not interleaving is performed, and indicates at least one of an REG bundle size, an interleave size and a shift index when interleaving is performed).

Furthermore, ControlResourceSet illustrated in FIG. 8 may include at least one IE illustrated in FIG. 3B. In addition, a hierarchical structure or an association of the above information is only one example, and is not limited to this. The information that indicates a plurality of FDM resources configured by performing frequency division multiplexing on the frequency domain resource assigned to the CORESET associated with the paging search space only needs to be configured to the UE.

The UE may configure the frequency domain resource of the CORESET associated with the paging search space based on frequencyDomainResources in the CORESET configuration information (ControlResouceSet) illustrated in FIG. 8, and configure each FDM resource in the frequency domain resource based on the number of FDM resources (fdm-FreqDomainResources) in the frequency domain resource.

For example, in FIG. 7, the UE can assign three FDM resources in the CORESET #1 associated with the paging search space. At least one of the number and positions (e.g., starting PRB index) of frequency resource units (e.g., PRBs) that make up each FDM resource may be determined based on the number of frequency resource units (e.g., PRBs) assigned to the entire frequency domain resource assigned to the CORESET #1, and the number N_{fdm} of (e.g., 3 in FIG. 7) FDM resources in the frequency domain resource.

The UE can determine an FDM resource for receiving (monitoring) paging DCI from a plurality of FDM resources of a CORESET associated with a paging search space assigned as described above based on UE_ID by using, for example, above equation 5.

As described above, according to the third aspect, a plurality of FDM resources in the CORESET associated with the paging search space are assigned, and the CORESET in which each of a plurality of UEs receives paging DCI is determined among a plurality of these FDM resources based on UE_ID. Consequently, when pagings of a plurality of UEs are frequency-multiplexed, it is possible to appropriately control reception of a paging for the own UE.

(Radio Communication System)

The configuration of the radio communication system according to the present embodiment will be described below. This radio communication system uses one or a combination of the radio communication method according to each of the above embodiment of the present disclosure to perform communication.

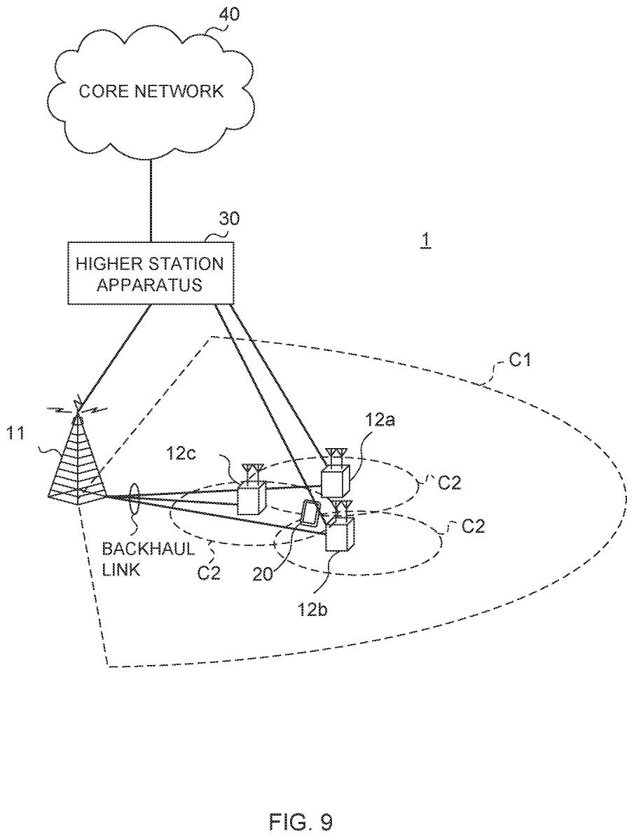

FIG. 9 is a diagram illustrating one example of a schematic configuration of the radio communication system according to the present embodiment. A radio communication system 1 can apply Carrier Aggregation (CA) and/or Dual Connectivity (DC) that aggregate a plurality of base frequency blocks (component carriers) whose 1 unit is a system bandwidth (e.g., 20 MHz) of the LTE system.

In this regard, the radio communication system 1 may be referred to as Long Term Evolution (LTE), LTE-Advanced (LTE-A), LTE-Beyond (LTE-B), SUPER 3G, IMT-Advanced, the 4th generation mobile communication system (40), the 5th generation mobile communication system (5G), New Radio (NR), Future Radio Access (FRA) and the New Radio Access Technology (New-RAT), or a system that realizes these techniques.

The radio communication system 1 includes a base station 11 that forms a macro cell C1 of a relatively wide coverage, and base stations 12 (12a to 12c) that are located in the macro cell C1 and form small cells C2 narrower than the macro cell C1. Furthermore, a user terminal 20 is located in the macro cell C1 and each small cell C2. An arrangement and the numbers of respective cells and the user terminals 20 are not limited to the aspect illustrated in FIG. 9.

The user terminal 20 can connect with both of the base station 11 and the base stations 12. The user terminal 20 is assumed to concurrently use the macro cell C1 and the small cells C2 by using CA or DC. Furthermore, the user terminal 20 can apply CA or DC by using a plurality of cells (CCs).

Furthermore, the radio communication system 1 may support dual connectivity between a plurality of Radio Access Technologies (RATs) (Multi-RAT Dual Connectivity (MR-DC)). MR-DC may include, for example, dual connectivity of LTE and NR (EN-DC: E-UTRA-NR Dual Connectivity) where a base station (eNB) of LTE (E-UTRA) is a Master Node (MN), and a base station (gNB) of NR is a Secondary Node (SN), and dual connectivity of NR and LTE (NE-DC: NR-E-UTRA Dual Connectivity) where a base station (gNB) of NR is an MN, and a base station (eNB) of LTE (E-UTRA) is an SN.

The user terminal 20 and the base station 11 can communicate by using a carrier (also referred to as a legacy carrier) of a narrow bandwidth in a relatively low frequency band (e.g., 2 GHz). On the other hand, the user terminal 20 and each base station 12 may use a carrier of a wide bandwidth in a relatively high frequency band (e.g., 3.5 GHz or 5 GHz) or may use the same carrier as that used between the user terminal 20 and the base station 11. In this regard, a configuration of the frequency band used by each base station is not limited to this.

Furthermore, the user terminal 20 can perform communication by using Time Division Duplex (TDD) and/or Frequency Division Duplex (FDD) in each cell. Furthermore, each cell (carrier) may be applied a single numerology or may be applied a plurality of different numerologies.

The numerology may be a communication parameter to be applied to transmission and/or reception of a certain signal and/or channel, and may indicate at least one of, for example, a subcarrier spacing, a bandwidth, a symbol length, a cyclic prefix length, a subframe length, a TTI length, the number of symbols per TTI, a radio frame configuration, specific filtering processing performed by a transceiver in a frequency domain, and specific windowing processing performed by the transceiver in a time domain. For example, a case where subcarrier spacings of constituent OFDM symbols are different and/or a case where the numbers of OFDM symbols are different on a certain physical channel may be read as that numerologies are different.

The base station 11 and each base station 12 (or the two base stations 12) may be connected by way of wired connection (e.g., optical fibers compliant with a Common Public Radio Interface (CPRI) or an X2 interface) or radio connection.

The base station 11 and each base station 12 are each connected with a higher station apparatus 30 and connected with a core network 40 via the higher station apparatus 30. In this regard, the higher station apparatus 30 includes, for example, an access gateway apparatus, a Radio Network Controller (RNC) and a Mobility Management Entity (MME), yet is not limited to these. Furthermore, each base station 12 may be connected with the higher station apparatus 30 via the base station 11.

In this regard, the base station 11 is a base station that has a relatively wide coverage, and may be referred to as a macro base station, an aggregate node, an eNodeB (eNB) or a transmission/reception point. Furthermore, each base station 12 is a base station that has a local coverage, and may be referred to as a small base station, a micro base station, a pico base station, a femto base station, a Home eNodeB (HeNB), a Remote Radio Head (RRH) or a transmission/reception point. The base stations 11 and 12 will be collectively referred to as a base station 10 below when not distinguished.

Each user terminal 20 is a terminal that supports various communication schemes such as LTE and LTE-A, and may include not only a mobile communication terminal (mobile station) but also a fixed communication terminal (fixed station).

The radio communication system 1 applies Orthogonal Frequency-Division Multiple Access (OFDMA) to downlink and applies Single Carrier-Frequency Division Multiple Access (SC-FDMA) and/or OFDMA to uplink as radio access schemes.

OFDMA is a multicarrier transmission scheme that divides a frequency band into a plurality of narrow frequency bands (subcarriers) and maps data on each subcarrier to perform communication. SC-FDMA is a single carrier transmission scheme that divides a system bandwidth into bands including one or contiguous resource blocks per terminal and causes a plurality of terminals to use respectively different bands to reduce an inter-terminal interference. In this regard, uplink and downlink radio access schemes are not limited to a combination of these schemes, and other radio access schemes may be used.

The radio communication system 1 uses a downlink shared channel (PDSCH: Physical Downlink Shared Channel) shared by each user terminal 20, a broadcast channel (PBCH: Physical Broadcast Channel) and a downlink L1/L2 control channel as downlink channels. User data, higher layer control information and a System Information Block (SIB) are conveyed on the PDSCH. Furthermore, a Master Information Block (MIB) is conveyed on the PBCH.

The downlink L1/L2 control channel includes a Physical Downlink Control Channel (PDCCH), an Enhanced Physical Downlink Control Channel (EPDCCH), a Physical Control Format Indicator Channel (PCFICH), and a Physical Hybrid-ARQ Indicator Channel (PHICH). Downlink Control Information (DCI) including scheduling information of the PDSCH and/or the PUSCH is conveyed on the PDCCH.

In addition, DCI for scheduling DL data reception may be referred to as a DL assignment, and DCI for scheduling UL data transmission may be referred to as a UL grant.

The radio communication system 1 uses an uplink shared channel (PUSCH: Physical Uplink Shared Channel) shared by each user terminal 20, an uplink control channel (PUCCH: Physical Uplink Control Channel), and a random access channel (PRACH: Physical Random Access Channel) as uplink channels. User data and higher layer control information are conveyed on the PUSCH. Furthermore, downlink radio quality information (CQI: Channel Quality Indicator), transmission acknowledgement information and a Scheduling Request (SR) are conveyed on the PUCCH. A random access preamble for establishing connection with a cell is conveyed on the PRACH.

The radio communication system 1 conveys a Cell-specific Reference Signal (CRS), a Channel State Information-Reference Signal (CSI-RS), a DeModulation Reference Signal (DMRS) and a Positioning Reference Signal (PRS) as downlink reference signals. Furthermore, the radio communication system 1 conveys a Sounding Reference Signal (SRS) and a DeModulation Reference Signal (DMRS) as uplink reference signals. In this regard, the DMRS may be referred to as a user terminal-specific reference signal (UE-specific reference signal). Furthermore, a reference signal to be conveyed is not limited to these.

<Base Station>

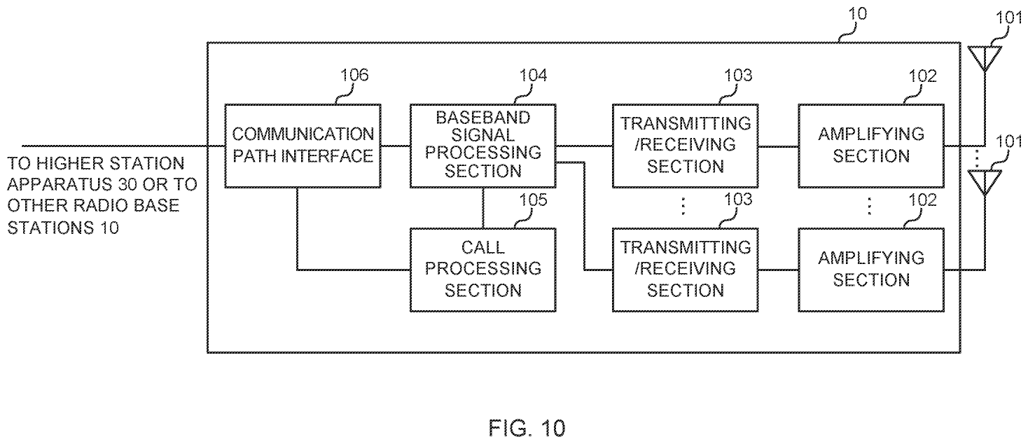

FIG. 10 is a diagram illustrating one example of an overall configuration of the base station according to the present embodiment. The base station 10 includes pluralities of transmission/reception antennas 101, amplifying sections 102 and transmitting/receiving sections 103, a baseband signal processing section 104, a call processing section 105 and a communication path interface 106. In this regard, the base station 10 only needs to be configured to include one or more of each of the transmission/reception antennas 101, the amplifying sections 102 and the transmitting/receiving sections 103.

User data transmitted from the base station 10 to the user terminal 20 on downlink is input from the higher station apparatus 30 to the baseband signal processing section 104 via the communication path interface 106.

The baseband signal processing section 104 performs processing of a Packet Data Convergence Protocol (PDCP) layer, segmentation and concatenation of the user data, transmission processing of a Radio Link Control (RLC) layer such as RLC retransmission control, Medium Access Control (MAC) retransmission control (e.g., HARQ transmission processing), and transmission processing such as scheduling, transmission format selection, channel coding, Inverse Fast Fourier Transform (IFFT) processing, and precoding processing on the user data, and transfers the user data to each transmitting/receiving section 103. Furthermore, the baseband signal processing section 104 performs transmission processing such as channel coding and inverse fast Fourier transform on a downlink control signal, too, and transfers the downlink control signal to each transmitting/receiving section 103.

Each transmitting/receiving section 103 converts a baseband signal precoded and output per antenna from the baseband signal processing section 104 into a radio frequency range, and transmits a radio frequency signal. The radio frequency signal subjected to frequency conversion by each transmitting/receiving section 103 is amplified by each amplifying section 102, and is transmitted from each transmission/reception antenna 101. The transmitting/receiving sections 103 can be composed of transmitters/receivers, transmission/reception circuits or transmission/reception apparatuses described based on a common knowledge in a technical field according to the present disclosure. In this regard, the transmitting/receiving sections 103 may be composed as an integrated transmission/reception section or may be composed of transmission sections and reception sections.

Meanwhile, each amplifying section 102 amplifies a radio frequency signal received by each transmission/reception antenna 101 as an uplink signal. Each transmitting/receiving section 103 receives the uplink signal amplified by each amplifying section 102. Each transmitting/receiving section 103 performs frequency conversion on the received signal into a baseband signal, and outputs the baseband signal to the baseband signal processing section 104.

The baseband signal processing section 104 performs Fast Fourier Transform (FIT) processing, Inverse Discrete Fourier Transform (IDFT) processing, error correcting decoding, MAC retransmission control reception processing, and reception processing of an RLC layer and a PDCP layer on user data included in the input uplink signal, and transfers the user data to the higher station apparatus 30 via the communication path interface 106. The call processing section 105 performs call processing (such as configuration and release) of a communication channel, state management of the base station 10 and radio resource management.

The communication path interface 106 transmits and receives signals to and from the higher station apparatus 30 via a given interface. Furthermore, the communication path interface 106 may transmit and receive (backhaul signaling) signals to and from the another base station 10 via an inter-base station interface (e.g., optical fibers compliant with the Common Public Radio Interface (CPRI) or the X2 interface).

In addition, each transmitting/receiving section 103 may further include an analog beam forming section that performs analog beam forming. The analog beam forming section can be composed of an analog beam forming circuit (e.g., a phase shifter or a phase shift circuit) or an analog beam forming apparatus (e.g., a phase shifter) described based on the common knowledge in the technical field according to the present invention. Furthermore, each transmission/reception antenna 101 can be composed of an array antenna, for example.

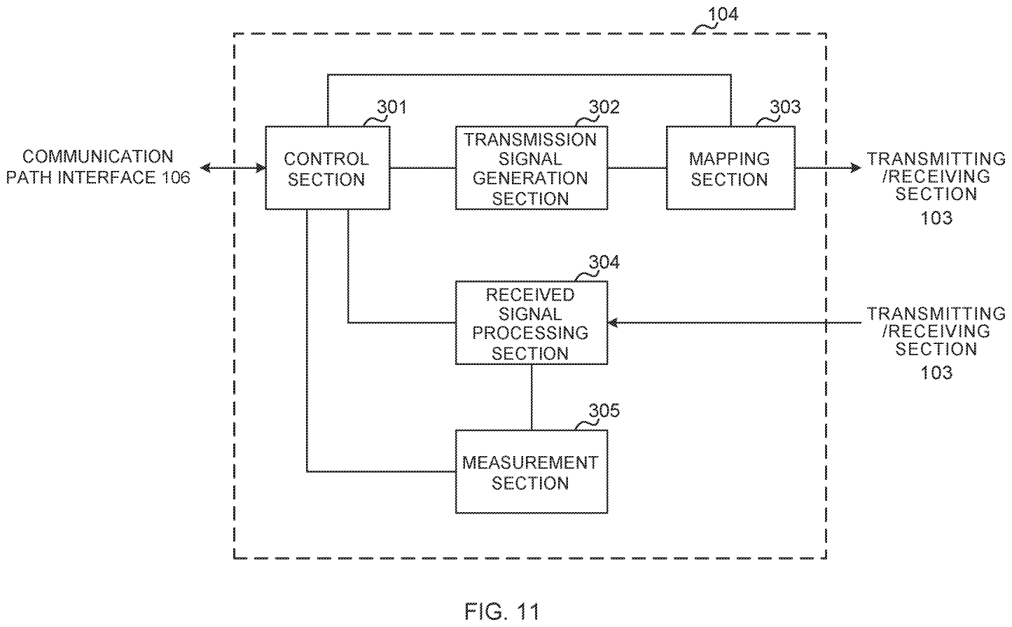

FIG. 11 is a diagram illustrating one example of a function configuration of the base station according to the present embodiment. In addition, this example mainly illustrates function blocks of characteristic portions according to the present embodiment, and may assume that the base station 10 includes other function blocks, too, that are necessary for radio communication.

The baseband signal processing section 104 includes at least the control section (scheduler) 301, a transmission signal generation section 302, a mapping section 303, a received signal processing section 304 and a measurement section 305. In addition, these components only need to be included in the base station 10, and part or all of the components may not be included in the baseband signal processing section 104.

The control section (scheduler) 301 controls the entire base station 10. The control section 301 can be composed of a controller, a control circuit or a control apparatus described based on the common knowledge in the technical field according to the present disclosure.

The control section 301 controls, for example, signal generation of the transmission signal generation section 302 and signal allocation of the mapping section 303. Furthermore, the control section 301 controls signal reception processing of the received signal processing section 304 and signal measurement of the measurement section 305.

The control section 301 controls scheduling (e.g., resource assignment) of system information, a downlink data signal (e.g., a signal that is transmitted on the PDSCH), and a downlink control signal (e.g., a signal that is transmitted on the PDCCH and is, for example, transmission acknowledgement information). Furthermore, the control section 301 controls generation of a downlink control signal and a downlink data signal based on a result obtained by deciding whether or not it is necessary to perform retransmission control on an uplink data signal.

The control section 301 controls scheduling of synchronization signals (e.g., a Primary Synchronization Signal (PSS)/a Secondary Synchronization Signal (SSS)), an SSB and downlink reference signals (e.g., a CRS, a CSI-RS and a DMRS).

The control section 301 controls scheduling of an uplink data signal (e.g., a signal that is transmitted on the PUSCH), an uplink control signal (e.g., a signal that is transmitted on the PUCCH and/or the PUSCH and is, for example, transmission acknowledgement information), a random access preamble (e.g., a signal that is transmitted on the PRACH) and an uplink reference signal.

The control section 301 may perform control for forming a transmission beam and/or a reception beam by using digital BF (e.g., precoding) in the baseband signal processing section 104 and/or analog BF (e.g., phase rotation) in each transmitting/receiving section 103. The control section 301 may perform control for forming a beam based on downlink channel information or uplink channel information. These pieces of channel information may be obtained from the received signal processing section 304 and/or the measurement section 305.

The transmission signal generation section 302 generates a downlink signal (such as a downlink control signal, a downlink data signal or a downlink reference signal) based on an instruction from the control section 301, and outputs the downlink signal to the mapping section 303. The transmission signal generation section 302 can be composed of a signal generator, a signal generating circuit or a signal generating apparatus described based on the common knowledge in the technical field according to the present disclosure.

The transmission signal generation section 302 generates, for example, a DL assignment for giving notification of downlink data allocation information, and/or a UL grant for giving notification of uplink data allocation information based on the instruction from the control section 301. The DL assignment and the UL grant are both DCI, and conform to a DCI format. Furthermore, the transmission signal generation section 302 performs encoding processing and modulation processing on the downlink data signal according to a code rate and a modulation scheme determined based on Channel State Information (CSI) from each user terminal 20.

The mapping section 303 maps the downlink signal generated by the transmission signal generation section 302, on given radio resources based on the instruction from the control section 301, and outputs the downlink signal to each transmitting/receiving section 103. The mapping section 303 can be composed of a mapper, a mapping circuit or a mapping apparatus described based on the common knowledge in the technical field according to the present disclosure.

The received signal processing section 304 performs reception processing (e.g., demapping, demodulation and decoding) on a received signal input from each transmitting/receiving section 103. In this regard, the received signal is, for example, an uplink signal (such as an uplink control signal, an uplink data signal or an uplink reference signal) transmitted from the user terminal 20. The received signal processing section 304 can be composed of a signal processor, a signal processing circuit or a signal processing apparatus described based on the common knowledge in the technical field according to the present disclosure.

The received signal processing section 304 outputs information decoded by the reception processing to the control section 301. When, for example, receiving the PUCCH including HARQ-ACK, the received signal processing section 304 outputs the HARQ-ACK to the control section 301. Furthermore, the received signal processing section 304 outputs the received signal and/or the signal after the reception processing to the measurement section 305.

The measurement section 305 performs measurement related to the received signal. The measurement section 305 can be composed of a measurement instrument, a measurement circuit or a measurement apparatus described based on the common knowledge in the technical field according to the present disclosure.

For example, the measurement section 305 may perform Radio Resource Management (RRM) measurement or Channel State Information (CSI) measurement based on the received signal. The measurement section 305 may measure received power (e.g., Reference Signal Received Power (RSRP)), received quality (e.g., Reference Signal Received Quality (RSRQ), a Signal to Interference plus Noise Ratio (SINR) or a Signal to Noise Ratio (SNR)), a signal strength (e.g., a Received Signal Strength Indicator (RSSI)) or channel information (e.g., CSI). The measurement section 305 may output a measurement result to the control section 301.

In addition, each transmitting/receiving section 103 may transmit at least one of downlink control information for a paging and a paging message. Furthermore, each transmitting/receiving section 103 may transmit various pieces of configuration information (e.g., at least one of above common PDCCH configuration information, CORESET configuration information and search space configuration information) and a higher layer parameter.

Furthermore, the control section 301 may determine a frequency domain resource used to receive the downlink control information from a plurality of frequency domain resources provided in a slot for monitoring the downlink control information based on a user terminal-specific identifier (e.g., a subscriber identify or an IMSI).

More specifically, a plurality of these frequency domain resources may be a plurality of control resource sets associated with a search space for the paging (first aspect). The control section 301 may determine a control resource set used to receive the downlink control information based on the user terminal-specific identifier and the number of a plurality of these control resource sets.

Furthermore, a plurality of these frequency domain resources may be a plurality of frequency domain resources configured in a single control resource set associated with the search space for the paging (second aspect). The control section 301 may determine a frequency domain resource used to receive the downlink control information based on the user terminal-specific identifier and the number of a plurality of these frequency domain resources configured in the single control resource set. The single control resource set may include at least ones of a plurality of contiguous frequency domain resource units and non-contiguous frequency domain resource units.

A plurality of these frequency domain resources may be a plurality of resources that are subjected to frequency division multiplexing in the single control resource set associated with the search space for the paging (third aspect). The control section 301 may determine a frequency domain resource used to receive the downlink control information based on the user terminal-specific identifier and the number of a plurality of these resources subjected to frequency division multiplexing in the single control resource set. The single control resource set may include a plurality of contiguous frequency domain resource units.

<User Terminal>

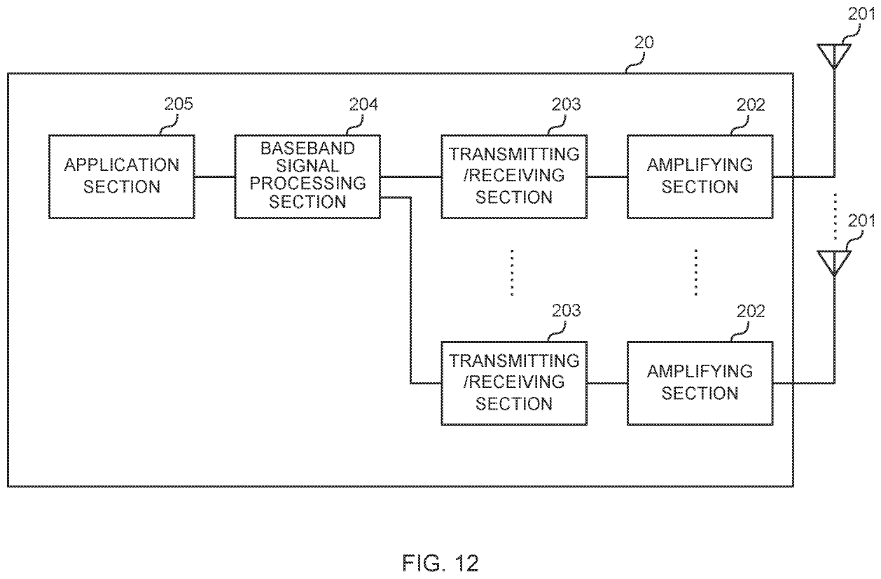

FIG. 12 is a diagram illustrating one example of an overall configuration of the user terminal according to the present embodiment. The user terminal 20 includes pluralities of transmission/reception antennas 201, amplifying sections 202 and transmitting/receiving sections 203, a baseband signal processing section 204 and an application section 205. In this regard, the user terminal 20 only needs to be configured to include one or more of each of the transmission/reception antennas 201, the amplifying sections 202 and the transmitting/receiving sections 203.

Each amplifying section 202 amplifies a radio frequency signal received at each transmission/reception antenna 201. Each transmitting/receiving section 203 receives a downlink signal amplified by each amplifying section 202. Each transmitting/receiving section 203 performs frequency conversion on the received signal into a baseband signal, and outputs the baseband signal to the baseband signal processing section 204. The transmitting/receiving sections 203 can be composed of transmitters/receivers, transmission/reception circuits or transmission/reception apparatuses described based on the common knowledge in the technical field according to the present disclosure. In this regard, the transmitting/receiving sections 203 may be composed as an integrated transmission/reception section or may be composed of transmission sections and reception sections.

The baseband signal processing section 204 performs FFT processing, error correcting decoding and retransmission control reception processing on the input baseband signal. The baseband signal processing section 204 transfers downlink user data to the application section 205. The application section 205 performs processing related to layers higher than a physical layer and an MAC layer. Furthermore, the baseband signal processing section 204 may transfer broadcast information of the downlink data, too, to the application section 205.

On the other hand, the application section 205 inputs uplink user data to the baseband signal processing section 204. The baseband signal processing section 204 performs retransmission control transmission processing (e.g., HARQ transmission processing), channel coding, precoding, Discrete Fourier Transform (DFT) processing and IFFT processing on the uplink user data, and transfers the uplink user data to each transmitting/receiving section 203.

Each transmitting/receiving section 203 converts the baseband signal output from the baseband signal processing section 204 into a radio frequency range, and transmits a radio frequency signal. The radio frequency signal subjected to the frequency conversion by each transmitting/receiving section 203 is amplified by each amplifying section 202, and is transmitted from each transmission/reception antenna 201.

In addition, each transmitting/receiving section 203 may further include an analog beam forming section that performs analog beam forming. The analog beam forming section can be composed of an analog beam forming circuit (e.g., a phase shifter or a phase shift circuit) or an analog beam forming apparatus (e.g., a phase shifter) described based on the common knowledge in the technical field according to the present invention. Furthermore, each transmission/reception antenna 201 can be composed of an array antenna, for example.

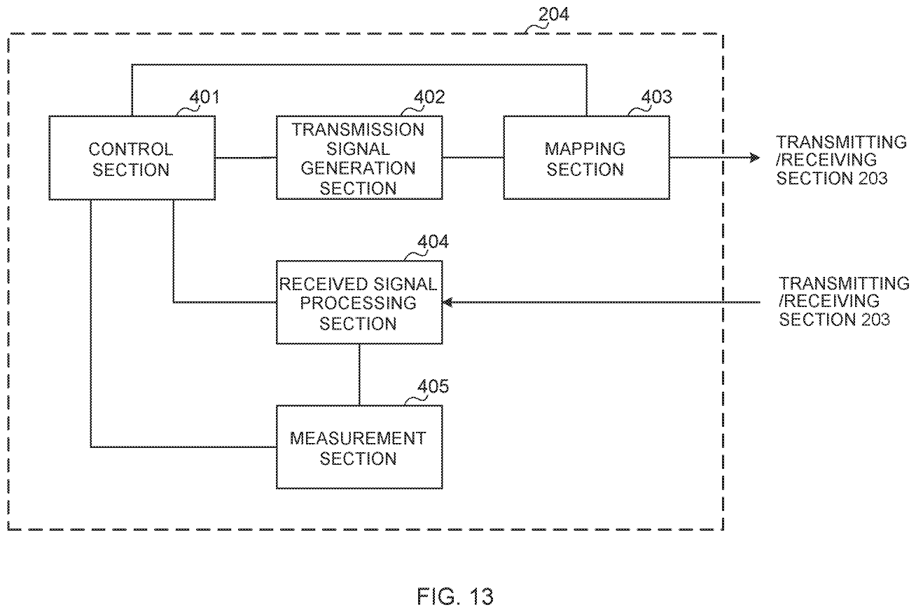

FIG. 13 is a diagram illustrating one example of a function configuration of the user terminal according to the present embodiment. In addition, this example mainly illustrates function blocks of characteristic portions according to the present embodiment, and may assume that the user terminal 20 includes other function blocks, too, that are necessary for radio communication.

The baseband signal processing section 204 of the user terminal 20 includes at least a control section 401, a transmission signal generation section 402, a mapping section 403, a received signal processing section 404 and a measurement section 405. In addition, these components only need to be included in the user terminal 20, and part or all of the components may not be included in the baseband signal processing section 204.

The control section 401 controls the entire user terminal 20. The control section 401 can be composed of a controller, a control circuit or a control apparatus described based on the common knowledge in the technical field according to the present disclosure.

The control section 401 controls, for example, signal generation of the transmission signal generation section 402 and signal allocation of the mapping section 403. Furthermore, the control section 401 controls signal reception processing of the received signal processing section 404 and signal measurement of the measurement section 405.

The control section 401 obtains from the received signal processing section 404 a downlink control signal and a downlink data signal transmitted from the base station 10. The control section 401 controls generation of an uplink control signal and/or an uplink data signal based on a result obtained by deciding whether or not it is necessary to perform retransmission control on the downlink control signal and/or the downlink data signal.

The control section 401 may perform control for forming a transmission beam and/or a reception beam by using digital BF (e.g., precoding) in the baseband signal processing section 204 and/or analog BF (e.g., phase rotation) in each transmitting/receiving section 203. The control section 401 may perform control for forming the beam based on the downlink channel information or the uplink channel information. These pieces of channel information may be obtained from the received signal processing section 404 and/or the measurement section 405.

When obtaining from the received signal processing section 404 various pieces of information notified from the base station 10, the control section 401 may update parameters used for control based on the various pieces of information.

The transmission signal generation section 402 generates an uplink signal (such as an uplink control signal, an uplink data signal or an uplink reference signal) based on an instruction from the control section 401, and outputs the uplink signal to the mapping section 403. The transmission signal generation section 402 can be composed of a signal generator, a signal generating circuit or a signal generating apparatus described based on the common knowledge in the technical field according to the present disclosure.

The transmission signal generation section 402 generates, for example, an uplink control signal related to transmission acknowledgement information and Channel State Information (CSI) based on the instruction from the control section 401. Furthermore, the transmission signal generation section 402 generates an uplink data signal based on the instruction from the control section 401. When, for example, the downlink control signal notified from the base station 10 includes a UL grant, the transmission signal generation section 402 is instructed by the control section 401 to generate an uplink data signal.

The mapping section 403 maps the uplink signal generated by the transmission signal generation section 402, on radio resources based on the instruction from the control section 401, and outputs the uplink signal to each transmitting/receiving section 203. The mapping section 403 can be composed of a mapper, a mapping circuit or a mapping apparatus described based on the common knowledge in the technical field according to the present disclosure.

The received signal processing section 404 performs reception processing (e.g., demapping, demodulation and decoding) on the received signal input from each transmitting/receiving section 203. In this regard, the received signal is, for example, a downlink signal (such as a downlink control signal, a downlink data signal or a downlink reference signal) transmitted from the base station 10. The received signal processing section 404 can be composed of a signal processor, a signal processing circuit or a signal processing apparatus described based on the common knowledge in the technical field according to the present disclosure. Furthermore, the received signal processing section 404 can compose the reception section according to the present disclosure.

The received signal processing section 404 outputs information decoded by the reception processing to the control section 401. The received signal processing section 404 outputs, for example, broadcast information, system information, an RRC signaling and DCI to the control section 401. Furthermore, the received signal processing section 404 outputs the received signal and/or the signal after the reception processing to the measurement section 405.

The measurement section 405 performs measurement related to the received signal. For example, the measurement section 405 may perform intra-frequency measurement and/or inter-frequency measurement on one or both of a first carrier and a second carrier. When the first carrier includes a serving cell, the measurement section 405 may perform inter-frequency measurement in the second carrier based on a measurement instruction obtained from the received signal processing section 404. The measurement section 405 can be composed of a measurement instrument, a measurement circuit or a measurement apparatus described based on the common knowledge in the technical field according to the present disclosure.

For example, the measurement section 405 may perform RRM measurement or CSI measurement based on the received signal. The measurement section 405 may measure received power (e.g., RSRP), received quality (e.g., RSRQ, an SINR or an SNR), a signal strength (e.g., RSSI) or channel information (e.g., CSI). The measurement section 405 may output a measurement result to the control section 401.

In addition, each transmitting/receiving section 203 may receive at least one of the downlink control information for the paging and the paging message. Furthermore, each transmitting/receiving section 203 may receive the various pieces of configuration information (e.g., at least one of the above common PDCCH configuration information, CORESET configuration information and search space configuration information) and the higher layer parameter.

Furthermore, the control section 401 may determine the frequency domain resource used to receive the downlink control information from a plurality of frequency domain resources provided in the slot for monitoring the downlink control information based on the user terminal-specific identifier (e.g., the subscriber identify or the IMSI).

More specifically, a plurality of these frequency domain resources may be a plurality of control resource sets associated with the search space for the paging (first aspect). The control section 401 may determine the control resource set used to receive the downlink control information based on the user terminal-specific identifier and the number of a plurality of these control resource sets.

Furthermore, a plurality of these frequency domain resources may be a plurality of frequency domain resources configured in the single control resource set associated with the search space for the paging (second aspect). The control section 401 may determine the frequency domain resource used to receive the downlink control information based on the user terminal-specific identifier and the number of a plurality of these frequency domain resources configured in the single control resource set. The single control resource set may include at least ones of a plurality of contiguous frequency domain resource units and the non-contiguous frequency domain resource units.

A plurality of these frequency domain resources may be a plurality of resources that are subjected to frequency division multiplexing in the single control resource set associated with the search space for the paging (third aspect). The control section 401 may determine the frequency domain resource used to receive the downlink control information based on the user terminal-specific identifier and the number of a plurality of these resources subjected to frequency division multiplexing in the single control resource set. The single control resource set may include a plurality of contiguous frequency domain resource units.

<Hardware Configuration>

In addition, the block diagrams used to describe the above embodiment illustrate blocks in function units. These function blocks (components) are realized by an arbitrary combination of at least one of hardware and software. Furthermore, a method for realizing each function block is not limited in particular. That is, each function block may be realized by using one physically or logically coupled apparatus or may be realized by using a plurality of these apparatuses formed by connecting two or more physically or logically separate apparatuses directly or indirectly (by using, for example, wired connection or radio connection). Each function block may be realized by combining software with the above one apparatus or a plurality of above apparatuses.

In this regard, the functions include judging, determining, deciding, calculating, computing, processing, deriving, investigating, looking up, ascertaining, receiving, transmitting, outputting, accessing, resolving, selecting, choosing, establishing, comparing, assuming, expecting, considering, broadcasting, notifying, communicating, forwarding, configuring, reconfiguring, allocating, mapping, and assigning, yet are not limited to these. For example, a function block (component) that causes transmission to function may be referred to as a transmitting unit or a transmitter. As described above, the method for realizing each function block is not limited in particular.

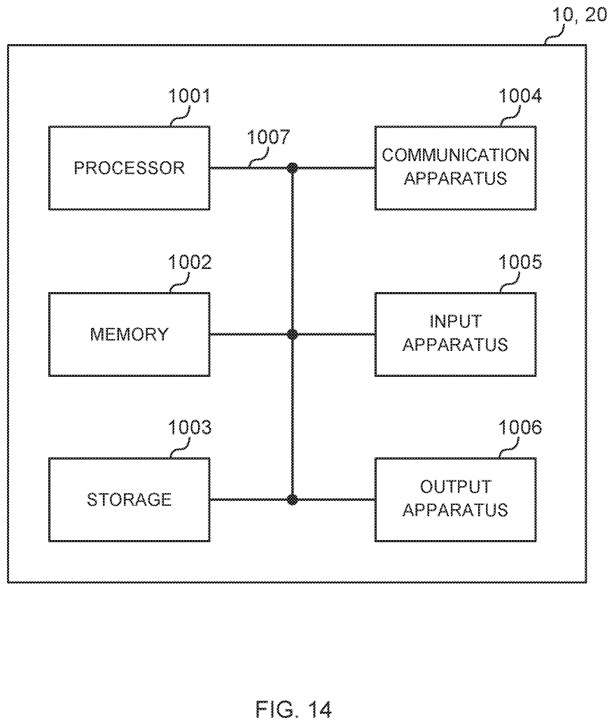

For example, the base station and the user terminal according to the present embodiment of the present disclosure may function as computers that perform processing of the radio communication method according to the present disclosure. FIG. 14 is a diagram illustrating one example of the hardware configurations of the base station and the user terminal according to the present embodiment. The above-described base station 10 and user terminal 20 may be each physically configured as a computer apparatus that includes a processor 1001, a memory 1002, a storage 1003, a communication apparatus 1004, an input apparatus 1005, an output apparatus 1006 and a bus 1007.

In this regard, words such as an apparatus, a circuit, a device, a section and a unit in the present disclosure can be interchangeably read. The hardware configurations of the base station 10 and the user terminal 20 may be configured to include one or a plurality of apparatuses illustrated in FIG. 14 or may be configured without including part of the apparatuses.

For example, FIG. 14 illustrates the only one processor 1001. However, there may be a plurality of processors. Furthermore, processing may be executed by 1 processor or processing may be executed by 2 or more processors concurrently or successively or by using another method. In addition, the processor 1001 may be implemented by 1 or more chips.

Each function of the base station 10 and the user terminal 20 is realized by, for example, causing hardware such as the processor 1001 and the memory 1002 to read given software (program), and thereby causing the processor 1001 to perform an operation, and control communication via the communication apparatus 1004 and control at least one of reading and writing of data in the memory 1002 and the storage 1003.

The processor 1001 causes, for example, an operating system to operate to control the entire computer. The processor 1001 may be composed of a Central Processing Unit (CPU) including an interface for a peripheral apparatus, a control apparatus, an operation apparatus and a register. For example, the above-described baseband signal processing section 104 (204) and call processing section 105 may be realized by the processor 1001.

Furthermore, the processor 1001 reads programs (program codes), a software module or data from at least one of the storage 1003 and the communication apparatus 1004 out to the memory 1002, and executes various types of processing according to these programs, software module or data. As the programs, programs that cause the computer to execute at least part of the operations described in the above-described embodiment are used. For example, the control section 401 of the user terminal 20 may be realized by a control program that is stored in the memory 1002 and operates on the processor 1001, and other function blocks may be also realized likewise.

The memory 1002 is a computer-readable recording medium, and may be composed of at least one of, for example, a Read Only Memory (ROM), an Erasable Programmable ROM (EPROM), an Electrically EPROM (EEPROM), a Random Access Memory (RAM) and other appropriate storage media. The memory 1002 may be referred to as a register, a cache or a main memory (main storage apparatus). The memory 1002 can store programs (program codes) and a software module that can be executed to perform the radio communication method according to the present embodiment of the present disclosure.

The storage 1003 is a computer-readable recording medium, and may be composed of at least one of, for example, a flexible disk, a floppy (registered trademark) disk, a magnetooptical disk (e.g., a compact disk (Compact Disc ROM (CD-ROM)), a digital versatile disk and a Blu-ray (registered trademark) disk), a removable disk, a hard disk drive, a smart card, a flash memory device (e.g., a card, a stick or a key drive), a magnetic stripe, a database, a server and other appropriate storage media. The storage 1003 may be referred to as an auxiliary storage apparatus.

The communication apparatus 1004 is hardware (transmission/reception device) that performs communication between computers via at least one of a wired network and a radio network, and is also referred to as, for example, a network device, a network controller, a network card and a communication module. The communication apparatus 1004 may be configured to include a high frequency switch, a duplexer, a filter and a frequency synthesizer to realize at least one of, for example, Frequency Division Duplex (FDD) and Time Division Duplex (TDD). For example, the above-described transmission/reception antennas 101 (201), amplifying sections 102 (202), transmitting/receiving sections 103 (203) and communication path interface 106 may be realized by the communication apparatus 1004. Each transmitting/receiving section 103 (203) may be physically or logically separately implemented as a transmitting section 103a (203a) and a receiving section 103b (203b).

The input apparatus 1005 is an input device (e.g., a keyboard, a mouse, a microphone, a switch, a button or a sensor) that accepts an input from an outside. The output apparatus 1006 is an output device (e.g., a display, a speaker or a Light Emitting Diode (LED) lamp) that sends an output to the outside. In addition, the input apparatus 1005 and the output apparatus 1006 may be an integrated component (e.g., touch panel).

Furthermore, each apparatus such as the processor 1001 or the memory 1002 is connected by the bus 1007 that communicates information. The bus 1007 may be composed by using a single bus or may be composed by using different buses between apparatuses.

Furthermore, the base station 10 and the user terminal 20 may be configured to include hardware such as a microprocessor, a Digital Signal Processor (DSP), an Application Specific Integrated Circuit (ASIC), a Programmable Logic Device (PLD) and a Field Programmable Gate Array (FPGA). The hardware may be used to realize part or entirety of each function block. For example, the processor 1001 may be implemented by using at least one of these hardware components.

### Modified Example

In addition, each term that has been described in the present disclosure and each term that is necessary to understand the present disclosure may be replaced with terms having identical or similar meanings. For example, a channel, a symbol and a signal (a signal or a signaling) may be interchangeably read. Furthermore, a signal may be a message. A reference signal can be also abbreviated as an RS (Reference Signal), or may be referred to as a pilot or a pilot signal depending on standards to be applied. Furthermore, a Component Carrier (CC) may be referred to as a cell, a frequency carrier and a carrier frequency.

A radio frame may include one or a plurality of durations (frames) in a time domain. Each of one or a plurality of durations (frames) that makes up a radio frame may be referred to as a subframe. Furthermore, the subframe may include one or a plurality of slots in the time domain. The subframe may be a fixed time duration (e.g., 1 ms) that does not depend on the numerologies.

In this regard, the numerology may be a communication parameter to be applied to at least one of transmission and reception of a certain signal or channel. The numerology may indicate at least one of, for example, a SubCarrier Spacing (SCS), a bandwidth, a symbol length, a cyclic prefix length, a Transmission Time Interval (TTI), the number of symbols per TTI, a radio frame configuration, specific filtering processing performed by a transceiver in a frequency domain, and specific windowing processing performed by the transceiver in a time domain.

The slot may include one or a plurality of symbols (Orthogonal Frequency Division Multiplexing (OFDM) symbols or Single Carrier-Frequency Division Multiple Access (SC-FDMA) symbols) in the time domain. Furthermore, the slot may be a time unit based on the numerologies.

The slot may include a plurality of mini slots. Each mini slot may include one or a plurality of symbols in the time domain. Furthermore, the mini slot may be referred to as a subslot. The mini slot may include a smaller number of symbols than those of the slot. The PDSCH (or the PUSCH) to be transmitted in larger time units than that of the mini slot may be referred to as a PDSCH (PUSCH) mapping type A. The PDSCH (or the PUSCH) to be transmitted by using the mini slot may be referred to as a PDSCH (PUSCH) mapping type B.

The radio frame, the subframe, the slot, the mini slot and the symbol each indicate a time unit for conveying signals. The other corresponding names may be used for the radio frame, the subframe, the slot, the mini slot and the symbol. In addition, time units such as a frame, a subframe, a slot, a mini slot and a symbol in the present disclosure may be interchangeably read.

For example, 1 subframe may be referred to as a TTI, a plurality of contiguous subframes may be referred to as TTIs, or 1 slot or 1 mini slot may be referred to as a TTI. That is, at least one of the subframe and the TTI may be a subframe (0 ms) according to legacy LTE, may be a duration (e.g., 1 to 13 symbols) shorter than 1 ms or may be a duration longer than 1 ms. In addition, a unit that indicates the TTI may be referred to as a slot or a mini slot instead of a subframe.

In this regard, the TTI refers to, for example, a minimum time unit of scheduling of radio communication. For example, in the LTE system, the base station performs scheduling for assigning radio resources (a frequency bandwidth or transmission power that can be used in each user terminal) in TTI units to each user terminal. In this regard, a definition of the TTI is not limited to this.

The TTI may be a transmission time unit of a channel-coded data packet (transport block), code block or codeword, or may be a processing unit of scheduling or link adaptation. In addition, when the TTI is given, a time period (e.g., the number of symbols) in which a transport block, a code block or a codeword is actually mapped may be shorter than the TTI.

In addition, when 1 slot or 1 mini slot is referred to as a TTI, 1 or more TTIs (i.e., 1 or more slots or 1 or more mini slots) may be a minimum time unit of scheduling. Furthermore, the number of slots (the number of mini slots) that make up a minimum time unit of the scheduling may be controlled.

The TTI having the time duration of 1 ms may be referred to as a general TTI (TTIs according to LTE Rel. 8 to 12), a normal TTI, a long TTI, a general subframe, a normal subframe, a long subframe or a slot. A TTI shorter than the general TTI may be referred to as a reduced TTI, a short TTI, a partial or fractional TTI, a reduced subframe, a short subframe, a mini slot, a subslot or a slot.

In addition, the long TTI (e.g., the general TTI or the subframe) may be read as a TTI having a time duration exceeding 1 ms, and the short TTI (e.g., the reduced TTI) may be read as a TTI having a TTI length less than the TTI length of the long TTI and equal to or more than 1 ms.

A Resource Block (RB) is a resource assignment unit of the time domain and the frequency domain, and may include one or a plurality of contiguous subcarriers in the frequency domain. The numbers of subcarriers included in RBs may be the same irrespectively of a numerology, and may be, for example, 12. The numbers of subcarriers included in the RBs may be determined based on the numerology.

Furthermore, the RB may include one or a plurality of symbols in the time domain or may have the length of 1 slot, 1 mini slot, 1 subframe or 1 TTI. 1 TTI or 1 subframe may each include one or a plurality of resource blocks.

In this regard, one or a plurality of RBs may be referred to as a Physical Resource Block (PRB: Physical RB), a Sub-Carrier Group (SCG), a Resource Element Group (REG), a PRB pair or an RB pair.

Furthermore, the resource block may include one or a plurality of Resource Elements (REs). For example, 1 RE may be a radio resource domain of 1 subcarrier and 1 symbol.

A Bandwidth Part (BWP) (that may be referred to as a partial bandwidth) may mean a subset of contiguous common Resource Blocks (common RBs) for a certain numerology in a certain carrier. In this regard, the common RB may be specified by an RB index based on a common reference point of the certain carrier. A PRB may be defined based on a certain BWP, and may be numbered in the certain BWP.

The BWP may include a BWP for UL (UL BWP) and a BWP for DL (DL BWP). One or a plurality of BWPs in 1 carrier may be configured to the UE.

At least one of the configured BWPs may be active, and the UE may not assume that a given signal/channel is transmitted and received outside the active BWP. In addition, a “cell” and a “carrier” in the present disclosure may be read as a “BWP”.

In this regard, structures of the above-described radio frame, subframe, slot, mini slot and symbol are only exemplary structures. For example, configurations such as the number of subframes included in a radio frame, the number of slots per subframe or radio frame, the number of mini slots included in a slot, the numbers of symbols and RBs included in a slot or a mini slot, the number of subcarriers included in an RB, the number of symbols in a TTI, a symbol length and a Cyclic Prefix (CP) length can be variously changed.

Furthermore, the information and the parameters described in the present disclosure may be expressed by using absolute values, may be expressed by using relative values with respect to given values or may be expressed by using other corresponding information. For example, a radio resource may be instructed by a given index.

Names used for parameters in the present disclosure are in no respect restrictive names. Furthermore, numerical expressions that use these parameters may be different from those explicitly disclosed in the present disclosure. Various channels (the Physical Uplink Control Channel (PUCCH) and the Physical Downlink Control Channel (PDCCH)) and information elements can be identified based on various suitable names. Therefore, various names assigned to these various channels and information elements are in no respect restrictive names.

The information and the signals described in the present disclosure may be expressed by using one of various different techniques. For example, the data, the instructions, the commands, the information, the signals, the bits, the symbols and the chips mentioned in the above entire description may be expressed as voltages, currents, electromagnetic waves, magnetic fields or magnetic particles, optical fields or photons, or arbitrary combinations of these.

Furthermore, the information and the signals can be output at least one of from a higher layer to a lower layer and from the lower layer to the higher layer. The information and the signals may be input and output via a plurality of network nodes.

The input and output information and signals may be stored in a specific location (e.g., memory) or may be managed by using a management table. The information and signals to be input and output can be overridden, updated or additionally written. The output information and signals may be deleted. The input information and signals may be transmitted to other apparatuses.

Notification of information is not limited to the aspects/embodiment described in the present disclosure and may be performed by using other methods. For example, the information may be notified by a physical layer signaling (e.g., Downlink Control Information (DCI) and Uplink Control Information (UCI)), a higher layer signaling (e.g., a Radio Resource Control (RRC) signaling, broadcast information (a Master Information Block (MIB) and a System Information Block (SIB)), and a Medium Access Control (MAC) signaling), other signals or combinations of these.

In addition, the physical layer signaling may be referred to as Layer 1/Layer 2 (L1/L2) control information (L1/L2 control signal) or L1 control information (L1 control signal). Furthermore, the RRC signaling may be referred to as an RRC message, and may be, for example, an RRCConnectionSetup message or an RRCConnectionReconfiguration message. Furthermore, the MAC signaling may be notified by using, for example, an MAC Control Element (MAC CE).

Furthermore, notification of given information (e.g., notification of “being X”) is not limited to explicit notification, and may be given implicitly (by, for example, not giving notification of the given information or by giving notification of another information).

Decision may be made based on a value (0 or 1) expressed as 1 bit, may be made based on a boolean expressed as true or false or may be made by comparing numerical values (by, for example, making comparison with a given value).

Irrespectively of whether software is referred to as software, firmware, middleware, a microcode or a hardware description language or is referred to as other names, the software should be widely interpreted to mean a command, a command set, a code, a code segment, a program code, a program, a subprogram, a software module, an application, a software application, a software package, a routine, a subroutine, an object, an executable file, an execution thread, a procedure or a function.

Furthermore, software, commands and information may be transmitted and received via transmission media. When, for example, the software is transmitted from websites, servers or other remote sources by using at least ones of wired techniques (e.g., coaxial cables, optical fiber cables, twisted pairs and Digital Subscriber Lines (DSLs)) and radio techniques (e.g., infrared rays and microwaves), at least ones of these wired techniques and radio techniques are included in a definition of the transmission media.

The terms “system” and “network” used in the present disclosure can be interchangeably used.

In the present disclosure, terms such as “precoding”, a “precoder”, a “weight (precoding weight)”, “Quasi-Co-Location (QCL)”, a “Transmission Configuration Indication state (TCI State)”, a “spatial relation”, a “spatial domain filter”, “transmission power”, “phase rotation”, an “antenna port”, an “antenna port group”, a “layer”, “the number of layers”, a “rank”, a “resource”, a “resource set”, a “resource group”, a “beam”, a “beam width”, a “beam angle”, an “antenna”, an “antenna element” and a “panel” can be interchangeably used.

In the present disclosure, terms such as a “base Station (BS)”, a “radio base station”, a “fixed station”, a “NodeB”, an “eNodeB (eNB)”, a “gNodeB (gNB)”, an “access point”, a “Transmission Point (TP)”, a “Reception Point (RP)”, a “Transmission/Reception Point (TRP)”, a “panel”, a “cell”, a “sector”, a “cell group”, a “carrier” and a “component carrier” can be interchangeably used. The base station is also referred to as terms such as a macro cell, a small cell, a femtocell or a picocell.

The base station can accommodate one or a plurality of (e.g., three) cells. When the base station accommodates a plurality of cells, an entire coverage area of the base station can be partitioned into a plurality of smaller areas. Each smaller area can also provide a communication service via a base station subsystem (e.g., indoor small base station (RRH: Remote Radio Head)). The term “cell” or “sector” indicates part or the entirety of the coverage area of at least one of the base station and the base station subsystem that provide a communication service in this coverage.

In the present disclosure, the terms such as “Mobile Station (MS)”, “user terminal”, “user apparatus (UE: User Equipment)” and “terminal” can be interchangeably used.

The mobile station is also referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or some other appropriate terms in some cases.

At least one of the base station and the mobile station may be referred to as a transmission apparatus, a reception apparatus or a radio communication apparatus. In addition, at least one of the base station and the mobile station may be a device mounted on a movable body or the movable body itself. The movable body may be a vehicle (e.g., a car or an airplane), may be a movable body (e.g., a drone or a self-driving car) that moves unmanned or may be a robot (a manned type or an unmanned type). In addition, at least one of the base station and the mobile station includes an apparatus, too, that does not necessarily move during a communication operation. For example, at least one of the base station and the mobile station may be an Internet of Things (IoT) device such as a sensor.

Furthermore, the base station in the present disclosure may be read as the user terminal. For example, each aspect/embodiment of the present disclosure may be applied to a configuration where communication between the base station and the user terminal is replaced with communication between a plurality of user terminals (that may be referred to as, for example, Device-to-Device (D2D) or Vehicle-to-Everything (V2X)). In this case, the user terminal 20 may be configured to include the functions of the above-described base station 10. Furthermore, words such as “uplink” and “downlink” may be read as a word (e.g., a “side”) that matches terminal-to-terminal communication. For example, the uplink channel and the downlink channel may be read as side channels.

Similarly, the user terminal in the present disclosure may be read as the base station. In this case, the base station 10 may be configured to include the functions of the above-described user terminal 20.

In the present disclosure, operations performed by the base station are performed by an upper node of this base station depending on cases. Obviously, in a network including one or a plurality of network nodes including the base stations, various operations performed to communicate with a terminal can be performed by base stations, one or more network nodes (that are regarded as, for example, Mobility Management Entities (MMEs) or Serving-Gateways (S-GWs), yet are not limited to these) other than the base stations or a combination of these.

Each aspect/embodiment described in the present disclosure may be used alone, may be used in combination or may be switched and used when carried out. Furthermore, orders of the processing procedures, the sequences and the flowchart according to each aspect/embodiment described in the present disclosure may be rearranged unless contradictions arise. For example, the method described in the present disclosure presents various step elements by using an exemplary order and is not limited to the presented specific order.

Each aspect/embodiment described in the present disclosure may be applied to Long Term Evolution (LTE), LTE-Advanced (LTE-A), LTE-Beyond (LTE-B). SUPER 3G, IMT-Advanced, the 4th generation mobile communication system (40), the 5th generation mobile communication system (50), Future Radio Access (FRA), the New Radio Access Technology (New-RAT), New Radio (NR). New radio access (NX), Future generation radio access (FX), Global System for Mobile communications (GSM) (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other appropriate radio communication methods, or next-generation systems that are expanded based on these systems. Furthermore, a plurality of systems may be combined (e.g., a combination of LTE or LTE-A and 5G) and applied.

The phrase “based on” used in the present disclosure does not mean “based only on” unless specified otherwise. In other words, the phrase “based on” means both of “based only on” and “based at least on”.

Every reference to elements that use names such as “first” and “second” used in the present disclosure does not generally limit the quantity or the order of these elements. These names can be used in the present disclosure as a convenient method for distinguishing between two or more elements. Hence, the reference to the first and second elements does not mean that only two elements can be employed or the first element should precede the second element in some way.

The term “deciding (determining)” used in the present disclosure includes diverse operations in some cases. For example, “deciding (determining)” may be regarded to “decide (determine)” judging, calculating, computing, processing, deriving, investigating, looking up, search and inquiry (e.g., looking up in a table, a database or another data structure), and ascertaining.

Furthermore, “deciding (determining)” may be regarded to “decide (determine)” receiving (e.g., receiving information), transmitting (e.g., transmitting information), input, output and accessing (e.g., accessing data in a memory).

Furthermore. “deciding (determining)” may be regarded to “decide (determine)” resolving, selecting, choosing, establishing and comparing. That is, “deciding (determining)” may be regarded to “decide (determine)” some operation.

Furthermore, “deciding (determining)” may be read as “assuming”, “expecting” and “considering”.

“Maximum transmit power” disclosed in the present disclosure may mean a maximum value of transmit power, may mean the nominal UE maximum transmit power, or may mean the rated UE maximum transmit power.

The words “connected” and “coupled” used in the present disclosure or every modification of these words can mean every direct or indirect connection or coupling between 2 or more elements, and can include that 1 or more intermediate elements exist between the two elements “connected” or “coupled” with each other. The elements may be coupled or connected physically or logically or by a combination of these physical and logical connections. For example, “connection” may be read as “access”.

It can be understood in the present disclosure that, when connected, the two elements are “connected” or “coupled” with each other by using 1 or more electric wires, cables or printed electrical connection, and by using electromagnetic energy having wavelengths in radio frequency domains, microwave domains or (both of visible and invisible) light domains in some non-restrictive and non-comprehensive examples.

A sentence that “A and B are different” in the present disclosure may mean that “A and B are different from each other”. In this regard, the sentence may mean that “A and B are each different from C”. Words such as “separate” and “coupled” may be also interpreted in a similar way to “different”.

When the words “include” and “including” and modifications of these words are used in the present disclosure, these words intend to be comprehensive similar to the word “comprising”. Furthermore, the word “or” used in the present disclosure intends not to be an exclusive OR.

When, for example, translation adds articles such as a, an and the in English in the present disclosure, the present disclosure may include that nouns coming after these articles are plural.

The invention according to the present disclosure has been described in detail above. However, it is obvious for a person skilled in the art that the invention according to the present disclosure is not limited to the embodiment described in the present disclosure. The invention according to the present disclosure can be carried out as modified and changed aspects without departing from the gist and the scope of the invention defined based on the recitation of the claims. Accordingly, the description of the present disclosure is intended for exemplary explanation, and does not bring any restrictive meaning to the invention according to the present disclosure.

1. A user terminal comprising:
a receiving section that receives downlink control information for a paging; and
a control section that determines a frequency domain resource from a plurality of frequency domain resources based on a user terminal-specific identifier, the frequency domain resource being used to receive the downlink control information, and the plurality of frequency domain resources being provided in a slot for monitoring the downlink control information.

2. The user terminal according to claim 1, wherein
the plurality of frequency domain resources are a plurality of control resource sets associated with a search space for the paging, and
the control section determines a control resource set used to receive the downlink control information based on the user terminal-specific identifier and a number of the plurality of control resource sets.

3. The user terminal according to claim 1, wherein
the plurality of frequency domain resources are a plurality of frequency domain resources configured in a single control resource set associated with a search space for the paging, and
the control section determines a frequency domain resource used to receive the downlink control information based on the user terminal-specific identifier and a number of the plurality of frequency domain resources configured in the single control resource set.

4. The user terminal according to claim 3, wherein the single control resource set is configured in at least ones of a plurality of contiguous frequency domain resource units and non-contiguous frequency domain resource units.

5. The user terminal according to claim 1, wherein
the plurality of frequency domain resources are a plurality of resources subjected to frequency division multiplexing in a single control resource set associated with a search space for the paging, and
the control section determines a frequency domain resource used to receive the downlink control information based on the user terminal-specific identifier and a number of the plurality of resources subjected to the frequency division multiplexing in the single control resource set.

6. The user terminal according to claim 5, wherein the single control resource set is configured in a plurality of contiguous frequency domain resource units.
